(19) United States
(12) Patent Application Publication
(10) Pub. No.: US 2024/0330730 A1
(43) Pub. Date: Oct. 3, 2024

(54) QUANTUM CIRCUIT MAPPING USING REINFORCEMENT LEARNING TECHNIQUES

(71) Applicant: Amazon Technologies, Inc., Seattle, WA (US)

(72) Inventors: Yiheng Duan, Seattle, WA (US); Yunong Shi, Old Greenwich, CT (US)

(73) Assignee: Amazon Technologies, Inc., Seattle, WA (US)

(21) Appl. No.: 18/192,954

(22) Filed: Mar. 30, 2023

(51) Int. Cl. G06N 10/20; G06N 3/092

(52) U.S. Cl. CPC G06N 10/20; G06N 3/092

(57) ABSTRACT

Techniques for solving quantum circuit mapping problems using reinforcement learning techniques are disclosed. Quantum circuit mapping often requires the use of SWAP gates in order to configure logical quantum computations to be executed using fixed quantum hardware device layouts. A reinforcement learning model takes inputs such as a logical quantum circuit, a physical qubit connectivity graph corresponding to a quantum hardware device, and an initial qubit allocation scheme, and uses such information to schedule quantum gates of the logical quantum circuit for execution using respective physical qubits of the quantum hardware device. A reinforcement learning model that is configured to solve such quantum circuit mapping problems may comprise a neural network that is assisted by a Monte Carlo Tree Search (MCTS) algorithm, wherein the MCTS algorithm guides the neural network towards quantum circuit routing pathways which are more efficient (e.g., require fewer SWAP gates to be scheduled).

### BACKGROUND

Quantum computing utilizes the laws of quantum physics to process information. Quantum physics is a theory that describes the behavior of reality at the fundamental level. It is currently the only physical theory that is capable of consistently predicting the behavior of microscopic quantum objects like photons, molecules, atoms, and electrons.

A quantum computer is a device that utilizes quantum physics to allow one to write, store, process and read out information encoded in quantum states, e.g., the states of quantum objects. A quantum object is a physical object that behaves according to the laws of quantum physics. The state of a physical object is a description of the object at a given time.

In quantum physics, the state of a two-level quantum system, or simply, a qubit, is a list of two complex numbers whose squares sum up to one. Each of the two numbers is called an amplitude, or quasi-probability, and their squared absolute values are probabilities that a measurement of the qubit results in zero or one. A fundamental and counterintuitive difference between a probabilistic bit (e.g., a classical zero or one bit) and the qubit is that a probabilistic bit represents a lack of information about a two-level classical system, while a qubit contains maximal information about a two-level quantum system.

Quantum computers are based on such quantum bits (qubits), which may experience the phenomena of “superposition” and “entanglement.” Superposition allows a quantum system to be in multiple states at the same time. For example, whereas a classical computer is based on bits that are either zero or one, a qubit may be both zero and one at the same time, with different probabilities assigned to zero and one. Entanglement is a strong correlation between quantum systems, such that the quantum systems are inextricably linked even if separated by great distances.

A quantum algorithm comprises a reversible transformation acting on qubits in a desired and controlled way, followed by a measurement on one or multiple qubits. For example, if a system has two qubits, a transformation may modify four numbers; with three qubits this becomes eight numbers, and so on. As such, a quantum algorithm acts on a list of numbers exponentially large as dictated by the number of qubits. To implement a transform, the transform may be decomposed into small operations acting on a single qubit, or a pair of qubits, as an example. Such small operations may be called quantum gates and a specific arrangement of the quantum gates implements a quantum circuit.

There are different types of qubits that may be used in quantum computers, each having different advantages and disadvantages. For example, some quantum computers may include qubits built from superconductors, trapped ions, semiconductors, photonics, etc. Each may experience different levels of interference, errors and decoherence. Also, some may be more useful for generating particular types of quantum circuits or quantum algorithms, while others may be more useful for generating other types of quantum circuits or quantum algorithms. Also, costs, run-times, error rates, availability, etc. may vary across quantum computing technologies.

### BRIEF DESCRIPTION OF THE DRAWINGS

FIG. 1A illustrates a service provider network that enables customers to compile and execute quantum circuits using multiple quantum computing technologies, according to some embodiments.

FIG. 1B illustrates a quantum compilation service of the service provider network that enables customers to compile and generate mappings of logical quantum circuits to quantum hardware devices, according to some embodiments.

FIG. 2A illustrates interactions between components of a reinforcement learning model, applied via a reinforcement-learning-based (RL-based) quantum circuit router, during a given quantum circuit mapping determination session, according to some embodiments.

FIG. 2B illustrates interactions between components of a reinforcement learning model, applied via an RL-based quantum circuit router, during another given quantum circuit mapping determination session, according to some embodiments.

FIG. 3 illustrates a series of inputs that may be provided to an RL-based quantum circuit router during a quantum circuit mapping request, according to some embodiments.

FIG. 4 illustrates another series of inputs that may be provided to an RL-based quantum circuit router during another quantum circuit mapping request, according to some embodiments.

FIG. 5 illustrates yet another series of inputs that may be provided to an RL-based quantum circuit router during yet another quantum circuit mapping request, according to some embodiments.

FIGS. 6A and 6B illustrate possible playthrough scenarios of the quantum circuit mapping request described in FIG. 3, according to some embodiments.

FIG. 6C illustrates a Monte Carlo Tree Search (MCTS) diagram of the quantum circuit mapping request described in FIG. 3, according to some embodiments.

FIGS. 7A, 7B, and 7C illustrate possible playthrough scenarios of the quantum circuit mapping request described in FIG. 4, according to some embodiments.

FIG. 7D illustrates a Monte Carlo Tree Search (MCTS) diagram of the quantum circuit mapping request described in FIG. 4, according to some embodiments.

FIGS. 8A and 8B illustrate possible playthrough scenarios of the quantum circuit mapping request described in FIG. 5, according to some embodiments.

FIG. 8C illustrates a Monte Carlo Tree Search (MCTS) diagram of the quantum circuit mapping request described in FIG. 5, according to some embodiments.

FIG. 9 is a flowchart illustrating a process of applying reinforcement learning techniques to generate compiled instructions for a quantum circuit mapping request, according to some embodiments.

FIG. 10 is a flowchart illustrating a process of predicting results of applying reinforcement learning techniques to generate compiled instructions for a quantum circuit mapping request, according to some embodiments.

FIG. 11 illustrates edge computing devices of a quantum computing service physically located at quantum hardware provider locations, according to some embodiments.

FIG. 12 illustrates an example edge computing device connected to a quantum computing service, according to some embodiments.

FIG. 13 illustrates example interactions between a quantum computing service and an edge computing device of the quantum computing service, according to some embodiments.

FIG. 14 is a block diagram illustrating an example classical computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods and apparatus for enabling a logical quantum circuit to be executed on a given quantum hardware device according to said quantum hardware device's physical qubit connectivity graph (also referred to as a qubit interaction graph). Such a process may be referred to herein as a quantum circuit mapping. In some embodiments, logical computation that may be required to execute the logical quantum circuit may utilize more physical qubits than are available on the given quantum hardware device, and/or the logical computation may not be conducive to a given configuration of physical qubits and connected edges (also called a physical qubit connectivity graph). For example, a logical computation may assign for a gate to be performed between two physical qubits on a quantum hardware device which are not physically connected via an edge. In such cases, a “SWAP operation” (e.g., a SWAP gate) may be used to logically exchange the quantum states between two respective physical qubits, allowing for a circumvention of some physical limitations of the given quantum hardware device.

While SWAP operations (e.g., a SWAP gate) may extend the capability of a given quantum hardware device for executing logical operations by allowing for certain qubit states to be logically re-mapped, such SWAP operations may increase a duration of time required to execute a given logical quantum circuit. For example, a SWAP gate comprises three CNOT gates, which adds time to a total execution time of a logical quantum circuit. Furthermore, the three CNOT gates may introduce additional error and/or noise (e.g., crosstalk), and may therefore introduce additional difficulty in error correction of the quantum circuit. Therefore, it may be advantageous to minimize a number of SWAP operations (e.g., SWAP gates) that are implemented in a given quantum circuit mapping.

Solving for (e.g., generating an assignment wherein quantum gates of a given logical quantum circuit may be mapped to a physical qubit layout of a given quantum hardware device and executed using said quantum hardware device) and optimizing (e.g., minimizing a number of SWAP gates) a given quantum circuit mapping problem may be considered as an NP-hard (also referred to as NP-complete) optimization problem, and therefore a particular method and/or approach to efficiently determining solutions to such NP-hard problems may have importance. Rather than risk solving a lengthy and slow NP-hard minimization problem (e.g., via SMT solving methods, etc.), the methods and apparatus described herein relate to using machine learning techniques (e.g., reinforcement learning) to train a neural network to solve such quantum circuit mapping problems.

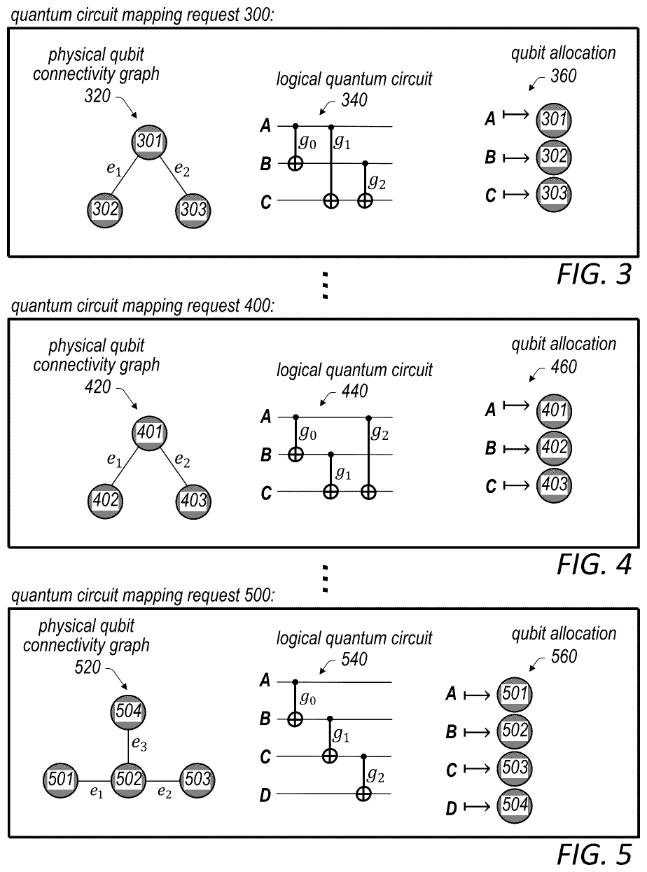

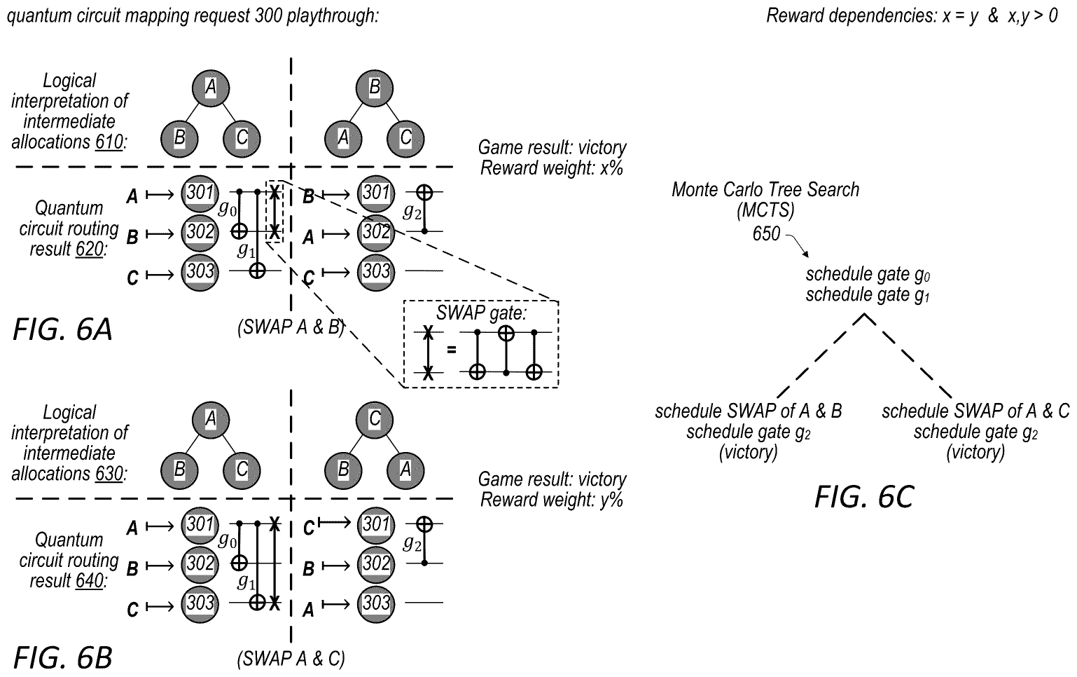

In some embodiments, a quantum circuit mapping problem may include two stages: a qubit allocation stage, and a quantum circuit routing stage. In a qubit allocation stage, logical qubits of a given logical quantum circuit may be respectively allocated to one or more physical qubits of a quantum hardware device. Examples of qubit allocation schemes are also discussed herein with regard to FIGS. 3, 4, and 5. In a quantum circuit routing stage, logical quantum gates of the logical quantum circuit are routed. Such a quantum circuit routing stage may also be referred to herein as a stage in which quantum gates are “scheduled” for execution. Examples of quantum circuit routing results are also discussed herein with regard to FIGS. 6A-8C. In some embodiments, one or more SWAP gates may additionally be scheduled during a quantum circuit routing stage. A person having ordinary skill in the art should understand that a scheduling of a SWAP gate may alter an initial or current qubit allocation scheme, as one or more of the logical qubits may be re-assigned to one or more different physical qubits of the quantum hardware device. Such alterations to an initial qubit allocation scheme may be referred to herein as intermediate qubit allocation schemes.

In some embodiments, a cloud-based quantum compilation service may orchestrate a process of solving for a quantum circuit mapping problem via the use of machine learning techniques (e.g., reinforcement learning). For example, computing devices of a service provider network may be configured to implement reinforcement-learning-based (RL-based) quantum circuit routers within a quantum compilation service. Such RL-based quantum circuit routing compute instances may then be configured to generate results to a quantum circuit mapping problem via the use of a policy-based neural network assisted by a Monte Carlo Tree Search (MCTS) algorithm.

In some embodiments, a system includes a service provider network comprising one or more computing devices that are configured to implement services of the service provider network such as a quantum compilation service, a quantum computing service, an optimization problem service, and/or other services that relate to enabling customers of the service provider network to seamlessly use one or more quantum computing technologies to execute logical quantum circuits and/or quantum algorithms. In the methods and apparatus described herein, a quantum algorithm and/or a quantum program may refer to one or more logical quantum circuits. For example, a quantum algorithm may comprise a second logical quantum circuit that depends on an outcome determined via a first logical quantum circuit, etc. In some embodiments, a quantum compilation service may be configured to receive and/or generate inputs for a given quantum circuit mapping problem and apply a reinforcement learning model, such as that which is described herein, to solve for solution(s) to the given quantum circuit mapping problem. The quantum compilation service may then generate compiled instructions for how to execute the logical quantum circuit(s) using a given quantum hardware device using the quantum circuit mapping solution(s). The quantum compilation service may then be additionally configured to provide the compiled instructions to a quantum computing service, which may orchestrate the execution of said logical quantum circuit(s) using the compiled instructions. An example quantum computing service is further described in the following paragraphs.

### Example Quantum Computing Service

Quantum computers may be difficult and costly to construct and operate. Also, there are varying quantum computing technologies under development with no clear trend as to which of the developing quantum computing technologies may gain prominence. Thus, potential users of quantum computers may be hesitant to invest in building or acquiring a particular type of quantum computer, as other quantum computing technologies may eclipse a selected quantum computing technology that a potential quantum computer user may invest in. Also, successfully using quantum computers to solve practical problems may require significant trial and error and/or otherwise require significant expertise in using quantum computers.

As an alternative to building and maintaining a quantum computer, potential users of quantum computers may instead prefer to rely on a quantum computing service to provide access to quantum computers. Also, in some embodiments, a quantum computing service, as described herein, may enable potential users of quantum computers to access quantum computers based on multiple different quantum computing technologies and/or paradigms, without the cost and resources required to build or manage such quantum computers. Also, in some embodiments, a quantum computing service, as described herein, may provide various services that simplify the experience of using a quantum computer such that potential quantum computer users lacking deep experience or knowledge of quantum mechanics, may, nevertheless, utilize quantum computing services to solve problems.

Also, in some embodiments, a quantum computing service, as described herein, may be used to supplement other services offered by a service provider network. For example, a quantum computing service may interact with a classical computing service to execute hybrid algorithms. In some embodiments, a quantum computing service may allow a classical computer to be accelerated by sending particular tasks to a quantum computer for execution, and then further performing additional classical compute operations using the results of the execution of a quantum computing object on the quantum computer. For example, a quantum computing service may allow for the acceleration of virtual machines implemented on classical hardware in a similar manner as a graphics processing unit (GPU) may accelerate graphical operations that otherwise would be performed on a central processing unit (CPU). A quantum computing service may also interact with other services offered by a service provider network such as a quantum compilation service described above.

In some embodiments, a quantum computing service may provide potential quantum computer users with access to quantum computers using various quantum computing technologies, such as quantum annealers, ion trap machines, superconducting machines, Rydberg atom arrays, photonic devices, etc. In some embodiments, a quantum computing service may provide customers with access to at least three broad categories of quantum computers including quantum annealers, circuit-based quantum computers, and analog or continuous variable quantum computers. As used herein, these three broad categories may be referred to as quantum computing paradigms.

In some embodiments, a quantum computing service may be configured to provide simulation services using classical hardware-based computing instances to simulate execution of a quantum circuit on a quantum computer. In some embodiments, a quantum computing service may be configured to perform general simulation and/or simulation that specifically simulates execution of a quantum circuit on a particular type of quantum computer of a particular quantum computer technology type or paradigm type. In some embodiments, simulation may be fully managed by a quantum computing service on behalf of a customer of the quantum computing service. For example, the quantum computing service may reserve sufficient computing capacity on a virtualized computing service of the service provider network to perform simulation without customer involvement in the details of managing the resources for the simulator.

In some embodiments, a quantum computing service may include a dedicated console that provides customers access to multiple quantum computing technologies. Furthermore, the quantum computing service may provide a quantum algorithm development kit that enables customers with varying levels of familiarity with quantum circuit design to design and execute quantum circuits. In some embodiments, a console of a quantum computing service may include various application programmatic interfaces (APIs), such as:
(Create/Delete/Update/Get/List) Simulator-Configuration-create, read, update, and delete (CRUD) operations for simulator configuration objects.
(Start/Cancel/Describe) Simulator-used to control each of the user-defined simulator instances.
(List/Describe) quantum processor units (QPUs)—retrieves quantum computer hardware information.
(Create/Cancel/List/Describe) Job-used to manage the lifecycle of a quantum job.
(Assign/Update/List) Quality of Service (QOS) guarantee-used to manage QoS guarantees for quantum jobs and/or quantum tasks.
(Create/Cancel/List/Describe) Task-used to manage the lifecycle of individual quantum tasks/quantum objects.

In some embodiments, a quantum algorithm development kit may include a graphical user interface, APIs or other interface to allow customers of a quantum computing service to define quantum objects, such as quantum tasks, algorithms or circuits, using the quantum algorithm development kit. In some embodiments, the quantum algorithm development kit may include an interface option that enables customers to share the quantum objects with other customers of the quantum computing service. For example, the quantum algorithm development kit may include a marketplace that allows customers to share or sell particular quantum objects with other customers. In some embodiments, the quantum algorithm development kit may include an interface element that allows customers to select a QoS to be applied for a quantum job or quantum tasks defined via the quantum algorithm development kit.

In some embodiments, a quantum computing service may include a public application programmatic interface (API) that accepts quantum objects submitted by a customer of the quantum computing service. In some embodiments, the quantum computing service may accept via the public API, or another API, instructions regarding a QoS guarantee to be used for one or more quantum jobs or quantum tasks, such as executing the quantum object received via the public API. Additionally, the quantum computing service may include a back-end API transport that is non-public. The back-end API transport may enable quantum circuits to be transported from a centralized location that implements the quantum computing service, such as one or more data centers of a service provider network, to an edge computing device at a particular quantum hardware provider location where the quantum circuit is to be executed. In some embodiments, quantum objects or quantum tasks may be executed using an internal QPU of the quantum computing service without using a back-end API transport to transport the quantum job or quantum task to an external quantum hardware provider location.

In some embodiments, results of the execution of a quantum circuit on a quantum computer at a quantum hardware provider location may be provided to the edge computing device at the quantum hardware provider location. The edge computing device may automatically transport the results to a secure storage service of the service provider network, where the customer can access the results using the storage service of the service provider network or via a console of the quantum computing service. Likewise, results of execution of a quantum circuit via an internal QPU may be accessed via the console of the quantum computing service.

In some embodiments, the results stored to the secure storage service may be seamlessly used by other services integrated into the service provider network, such as a machine learning service, a database service, an object-based storage service, a block-storage service, a data presentation service (that reformats the results into a more usable configuration), etc. For example, in some embodiments, a machine learning service may be used to optimize a quantum algorithm or quantum circuit. For example, the machine learning service may cause various versions of a quantum algorithm or quantum circuit to be run on a quantum computer via a quantum computing service. The machine learning service may also be provided access to results of running the quantum algorithms or quantum circuits. In some embodiments, the machine learning service may cause the quantum algorithms or quantum circuits to be run on various different quantum computing technology-based quantum computers. Based on the results, the machine learning service may determine one or more optimizations to improve the quantum algorithms or quantum circuits.

In some embodiments, a quantum computing service may support creating snapshots of results of executing a quantum circuit. For example, the quantum computing service may store snapshots of intermediate results of a hybrid algorithm or may more generally store snapshots of any results generated by executing a quantum circuit on a quantum computer. In some embodiments, an edge computing device at a hardware provider location may temporarily store results and may create snapshot copies of results stored on the edge computing device. The edge computing device may further cause the snapshot copies to be stored in an object-based data storage service of the service provider network. In some embodiments, snapshotting may not be performed, based on customer preferences.

Furthermore, as related to the description herein, it may be understood that quantum hardware, such as quantum hardware device(s), may be used to implement quantum computers, and/or various components of quantum computers (e.g., quantum processing units/cores (QPUs), routing spaces, magic state distillation factories, other components used to perform logical quantum computations, etc.). For example, a given quantum hardware device may resemble “building blocks” of a quantum computer, such as a grid (e.g., a one-dimensional grid, a two-dimensional grid, etc.) of qubits that may be initialized in various ways in order to form various components of a quantum computer, such as topological quantum codes. Quantum hardware devices may be further configured such that single qubit gates, multi-qubit gates, and/or other operations of quantum circuits may be performed between qubits of the quantum hardware devices (according to a given physical qubit connectivity graph of the quantum hardware device which details which physical qubits are connected to respective other physical qubits via edges). A person having ordinary skill in the art should also understand that, depending upon factors such as type(s) of qubit technologies used, type(s) of gates performed between said qubits, etc., quantum hardware devices may also comprise various control devices (e.g., function generators, devices for temperature, magnetic, and/or other environmental controls pertaining to local environments of the grid of qubits, etc.) that may be used to maintain and/or transform various properties of the qubits and/or other physical components of a given quantum computer. Moreover, a person having ordinary skill in the art should understand that a qubit may refer to both a logical bit (e.g., a one or a zero with some probability) and to one or more physical components used to construct the given qubit based, at least in part, on the type of qubit technology being applied. For example, a superconducting qubit (e.g., a transmon) may be constructed using at least a superconducting material and a non-superconducting material in which the non-superconducting material is located in between sections of superconducting material. With regard to this understanding, it should also be understood that quantum hardware may therefore be used to implement physical qubits, in ways such as those as described above, that may again be combined in various ways to implement one or more logical qubits such that logical quantum operations may be performed using said physical elements of said quantum hardware.

### Example Services and Interactions of a Service Provider Network

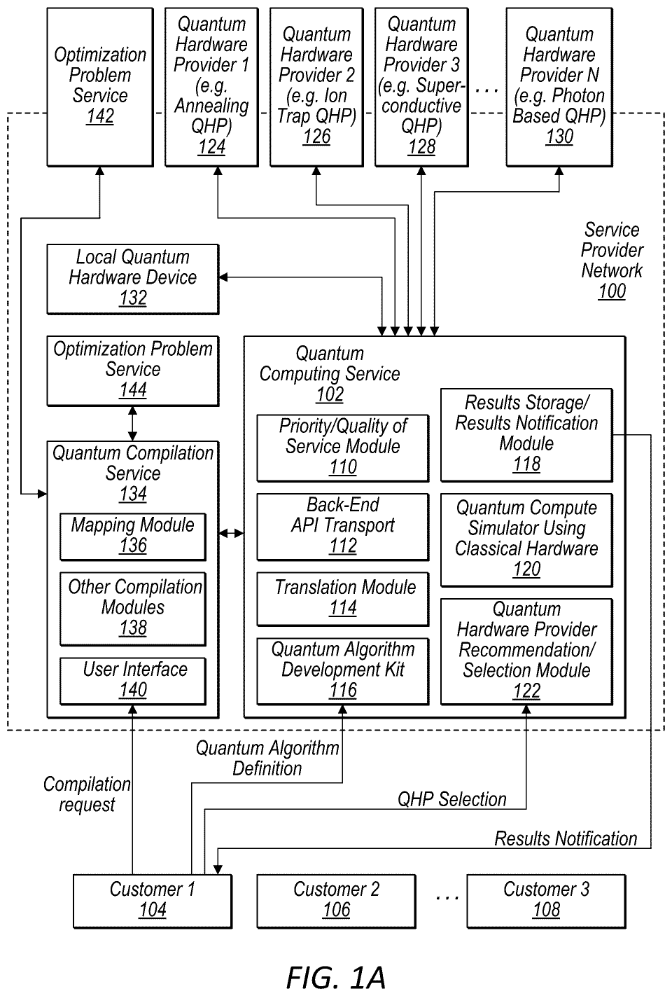

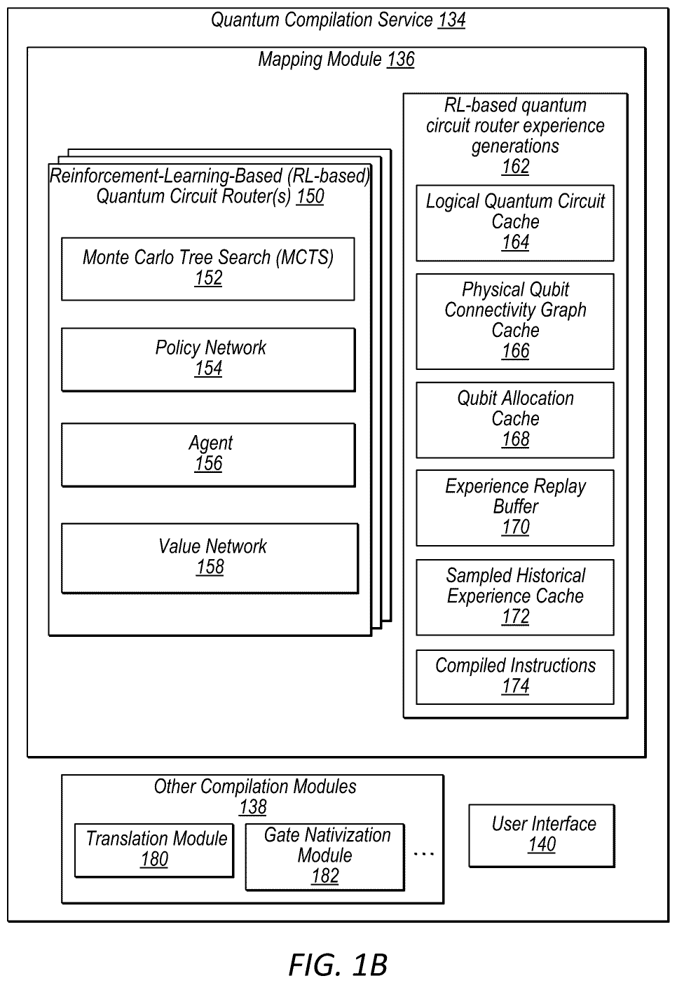

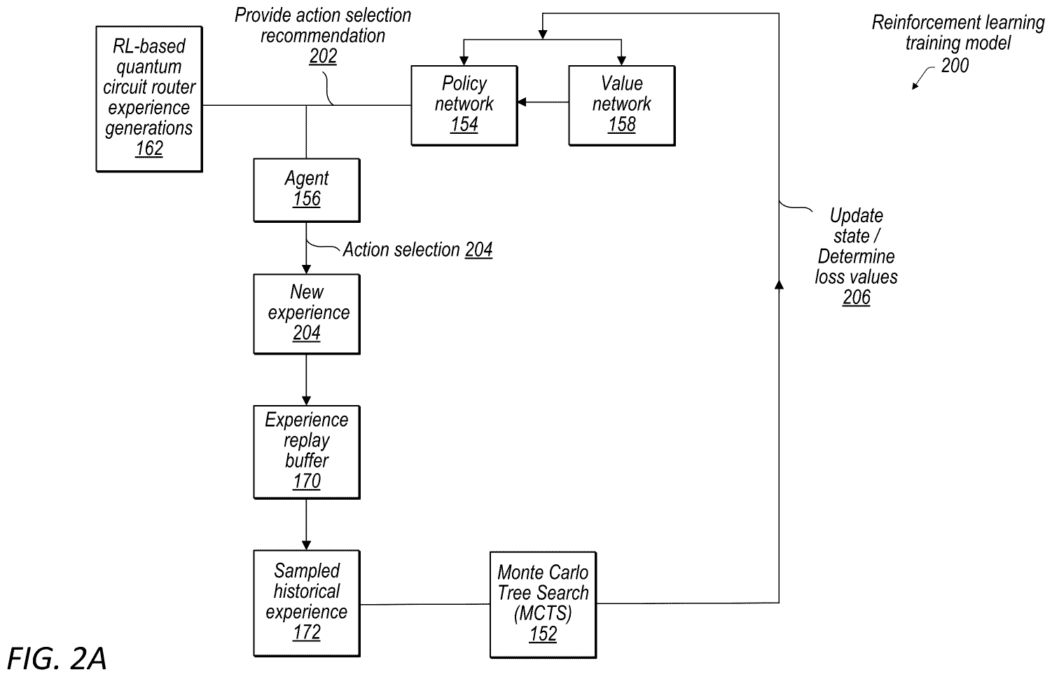

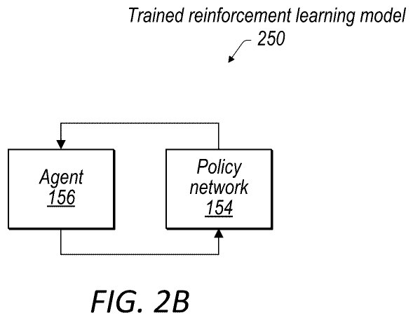

FIG. 1A illustrates a service provider network that enables customers to compile and execute quantum circuits using multiple quantum computing technologies, and FIG. 1B illustrates a quantum compilation service of the service provider network that enables customers to compile and generate mappings of logical quantum circuits to quantum hardware devices, according to some embodiments. Furthermore, FIGS. 2A and 2B illustrate interactions between components of a reinforcement learning model, applied via a reinforcement-learning-based quantum circuit router, during given quantum circuit mapping determination sessions, according to some embodiments.

In some embodiments, service provider network 100 may include various services such as quantum computing service 102, quantum compilation service 134, and optimization problem service 144, in addition to one or more other services that pertain to quantum compilation and computation. In some embodiments, service provider network 100 may include data centers, routers, networking devices, etc., such as of a cloud computing provider network. In some embodiments, customers 104, 106, and 108 and/or additional customers of service provider network 100 and/or quantum computing service 102, may be connected to the service provider network 100 in various ways, such as via a logically isolated connection over a public network, via a dedicated private physical connection, not accessible to the public, via a public Internet connection, etc.

In some embodiments, service provider network may include quantum compilation service 134. Quantum compilation service 134 may orchestrate one or more intermediate compilations (e.g., a compilation mapping of a logical quantum circuit to a given quantum hardware device structure, a compilation of gate nativization(s), translation of a quantum circuit into a quantum circuit specific to a given quantum hardware provider's design/language/architecture/technology, etc.) that may be used in order to take an input logical quantum circuit and conduct, via quantum computing service 102, the execution of said circuit using a given quantum hardware device of a given quantum hardware provider. Customers of service provider network 100 (e.g., customers 104, 106, 108, etc.) may interact with quantum compilation service 134 in order to submit compilation requests, etc., via user interface 140, according to some embodiments.

In some embodiments, user interface 140 may be implemented as a graphical user interface, wherein a customer of service provider network 100 may upload and/or provide quantum compilation service 134 with various information regarding a request for a quantum circuit mapping that the customer would like completed. However, user interface 140 may also be implemented as various types of programmatic (e.g., Application Programming Interfaces (APIs)) or command line interfaces to support the methods and systems described herein, according to some embodiments. Furthermore, user interface 140 may be a customer-facing interface in which a customer of compilation service 134 (e.g., customer 104) may submit inputs to be used for a given quantum circuit mapping problem. Alternatively, a customer (e.g., customer 104, 106, 108, etc.) of quantum computing service 102 may request that a quantum algorithm that they provide to quantum computing service 102 be executed using quantum hardware device(s) of a given quantum hardware provider (e.g., quantum hardware provider 124, 126, 128, 130, etc.). As part of the fulfillment of said request, the quantum algorithm may be divided into one or more logical quantum circuits that represent intermediate logical computations used within the overall quantum algorithm. Those logical quantum circuit(s) may then be provided by quantum computing service 102 to quantum compilation service 134 in order to generate quantum circuit mapping(s) of the logical quantum circuit(s) to quantum hardware device(s) of a given quantum hardware provider. In such embodiments, user interface 140 may not be a customer-facing interface but rather an interface (e.g., an API) between quantum computing service 102 and quantum compilation service 134.

In some embodiments, mapping module 136 may be used to compile instructions including a quantum circuit mapping such that a logical quantum circuit may be executed, via said compiled instructions, using a quantum hardware device. A person having ordinary skill in the art should understand that FIG. 1B is meant to be a visual representation of compute instances and/or program instructions that, when executed, cause one or more processors to implement the methods and apparatus described herein, and that additional configurations of FIG. 1B may exist that fulfill said implementations and are meant to be included herein. Furthermore, FIG. 1B describes components of RL-based quantum circuit router 150 as said components may be located within mapping module 136, and the interactions of components of RL-based quantum circuit router may be described via FIGS. 2A-2B, according to some embodiments.

A person having ordinary skill in the art of machine learning techniques should understand that the following terms and definitions may be used to describe reinforcement learning training model 200 within both the context of solving quantum circuit mapping problems herein and within the context of generally understood machine learning techniques. In general, reinforcement learning training model 200 describes “actions” selected by an “agent.” wherein actions change an “environment” of the agent in order to “play” a quantum circuit mapping “game.” Within a context of quantum circuit mapping and the context of the methods and techniques described herein, an agent may be described as “player” of the quantum circuit mapping game in which the agent is aided by a neural network (e.g., policy network 154) that determines a plurality of possible actions that change a current state of a quantum circuit mapping problem. An agent may then select an action from said plurality, and in some embodiments, the policy network may be further assisted via an MCTS algorithm that uses “inference” to determine predicted outcomes based on selecting respective ones of the actions. In addition, actions may be described herein as the scheduling of one or more SWAP gates. Furthermore, an “environment,” within the context of quantum circuit mapping, may be described via a current (e.g., initial, intermediate, final, etc.) state of a quantum circuit mapping problem, wherein an initial state of a quantum circuit mapping problem may be described as a state in which not all quantum gates of a logical quantum circuit have been scheduled for execution yet, an intermediate state of a quantum circuit mapping problem may be described as a state in which some additional quantum gates have been scheduled with respect to the initial state, and a final state of a quantum circuit mapping problem may be described as a state in which all quantum gates of the logical quantum circuit have been scheduled for execution, according to some embodiments.

As shown in FIG. 1B, RL-based quantum circuit router 150 may include compute resources configured to implement a neural network (e.g., policy network 154) that may be assisted via a Monte Carlo Tree Search (MCTS) algorithm (Monte Carlo Tree Search (MCTS) 152), according to some embodiments. In some embodiments, MCTS 152 may use a “tree search” method to identify predicted outcomes of various actions determined via policy network 154 and/or determine a loss associated with selecting those various actions. Examples of visual representations of MCTS algorithms are additionally discussed herein with regard to MCTS 650, 770, and 850.

In some embodiments, policy network 154 may be configured to connect a current state of the environment (e.g., a given quantum circuit mapping problem) to actions that said policy network may determine and/or select. Examples of guidelines that may be used to guide the training and/or action selections of policy network 154 may include the following. For example, a reinforcement learning model may select actions based, at least in part, on determining that certain actions of a plurality of actions will update a current state of the environment such that additional quantum gates of a given logical quantum circuit may be scheduled for execution (see also description pertaining to FIGS. 6A-8C herein). In another example, a reinforcement learning model may select actions based, at least in part, on gate dependencies of a given logical quantum circuit (e.g., a second quantum gate is dependent upon the output of a first quantum gate, etc.). A person having ordinary skill in the art should understand that RL model training guidelines are meant to be example guidelines that may be defined for an RL-based quantum circuit router and that additional and/or different guidelines may also be used to aid the direction of an RL-based quantum circuit router according to different mapping scenarios.

In some embodiments, agent 156 may additionally comprise a value network (e.g., value network 158), wherein said value network may be configured to determine quantum circuit routing rewards (e.g., reward distributions, reward weights, loss values, etc.) that may be used by policy network 154 to provide a recommendation of a given action of a plurality to select. Examples of guidelines that may be used to guide a distribution of rewards determined via value network 158 may include the following. For example, an agent of reinforcement learning training model 200 may be rewarded proportionally higher for selecting an action that results in one or more quantum gates of a given logical quantum circuit being scheduled than for selecting a different action that does not result in one or more quantum gates being scheduled. In another example, an agent of reinforcement learning training model 200 may be rewarded proportionally higher for successfully scheduling all quantum gates of a given logical quantum circuit (this has been shortened to “victory” in FIGS. 6A-8C) than for failing to schedule all quantum gates of the given logical quantum circuit (this may be shortened to “losing the game” and/or “loss,” as shown in FIGS. 6A-8C). In yet another example, an agent of reinforcement learning training model 200 may be rewarded proportionally higher for successfully scheduling all quantum gates of a given logical quantum circuit with a fewer number of scheduled SWAP gates than for successfully scheduling all quantum gates of the given logical quantum circuit with a larger number of scheduled SWAP gates, as this solves the given quantum circuit mapping problem using a more efficient path. A person having ordinary skill in the art should understand that such RL reward guidelines are meant to be example guidelines that may be defined for an RL-based quantum circuit router and that additional and/or different guidelines may also be used to aid the action recommendation determined via the RL model according to different mapping scenarios.

Mapping module 136 may additionally include various memory caches in order to provide RL-based quantum circuit router 150 with access to frequently used information. Such memory caches may be configured as compute resources of quantum compilation service 134, according to some embodiments. As shown in FIG. 1B, RL-based quantum circuit router experience generations 162 may include logical quantum circuit cache 164, physical qubit connectivity graph cache 166, qubit allocation cache 168, experience replay buffer 170, sampled historical experience cache, and compiled instructions 174. In some embodiments, logical quantum circuit cache may be used to store various logical quantum circuits that RL-based quantum circuit router 150 may be in the process of mapping (e.g., logical quantum circuit 340, 440, 540, etc.). In some embodiments, logical quantum circuit cache may store logical quantum circuits submitted by customers of service provider network 100, and/or logical quantum circuits used to train a given RL-based quantum circuit routing instance 150 (e.g., “training games”).

In some embodiments, physical qubit connectivity graph cache 166 may be used to store various physical qubit connectivity graphs corresponding to quantum hardware devices, such as quantum hardware devices of quantum hardware providers 124, 126, 128, and 130. Physical qubit connectivity graph cache 166 may store information pertaining to said quantum hardware devices, and/or may store information on how to request such information (e.g., via quantum computing service 102). Furthermore, physical qubit connectivity graph cache 166 may store physical qubit connectivity graphs (e.g., physical qubit connectivity graph 320, 420, 520, etc.), ordered lists of physical qubits and how they are connected to one another via edges, and/or any equivalent information that describes connectivities of physical qubits on a given quantum hardware device.

In some embodiments, qubit allocation cache 168 may be used to store various qubit allocation schemes (e.g., qubit allocation 360, 460, 560, etc.) that may be used during the solving of corresponding quantum circuit mapping problems. In some embodiments, a customer may submit a given qubit allocation scheme during submission of a given quantum circuit mapping request to quantum compilation service 134 and said qubit allocation scheme may be stored in qubit allocation cache 168. In other embodiments, quantum compilation service 134 may generate a qubit allocation scheme using information about a given logical quantum circuit stored in logical quantum circuit cache 164 and information about connectivity of a given quantum hardware device stored in physical qubit connectivity graph cache 166, and store said qubit allocation scheme in qubit allocation cache 168.

In some embodiments, experience replay buffer 170 may be used to store various states of an environment within a given quantum circuit mapping problem. For example, if an agent of RL-based quantum circuit router 150 has already selected a given number of actions, experience replay buffer 170 may store information pertaining to how the state of the environment has been updated following the selection of each of the selected actions. In another example, experience replay buffer 170 may store quantum circuit mapping determination scenarios that have already been completed by RL-based quantum circuit router 150 such that experience replay buffer 170 grows over time.

In some embodiments, sampled historical experience cache 172 may be used to store various quantum circuit mapping problems that have been previously solved and/or attempted by RL-based quantum circuit router 150. For example, an agent of RL-based quantum circuit router 150 may search sampled historical experience cache 172 to determine if a particular scenario and/or similar scenario during a current quantum circuit mapping problem has been solved for already in a previously attempted quantum circuit mapping problem.

In some embodiments, compiled instructions 174 may be used to store results to various on-going or previously completed quantum circuit mapping problems. For example, quantum compilation service 134 may be configured to compile instructions including a quantum circuit mapping result for executing a logical quantum circuit using a given quantum hardware device, and compiled instructions 174 may be used to retrieve said quantum circuit mapping result in order to compile the instructions, which may then be provided to quantum computing service 102. Generating compiled instructions is also discussed herein with regard to at least block 916.

In some embodiments, RL-based quantum circuit router experience generations 162 may additionally store information pertaining to simple quantum circuit mapping scenarios that may be used to train and/or improve reinforcement learning training model 200, such as quantum circuit mapping request 300, 400, and 500. Additionally or alternatively, such “training games” may include an ordered list of training scenarios that should be used to train and/or improve reinforcement learning training model 200 if program instructions were to be executed such that instances of RL-based quantum circuit router 150 were to be installed on additional servers (either inside or outside of service provider network 100). In some embodiments, such training games may be used in order to train RL-based quantum circuit router 150 via reinforcement learning training model 200. In other embodiments, trained reinforcement learning model 250 may include agent 156 and policy network 154, wherein policy network 154 already has some level of prior training via reinforcement learning training model 200. In some embodiments in which computing resources may be limited, it may be advantageous to apply trained reinforcement learning model 250 for a given quantum circuit mapping problem of a customer of service provider network 100.

In some embodiments, quantum compilation service 134 may also leverage multiple RL-based quantum circuit routing compute instances (e.g., RL-based quantum circuit router(s) 150) in order to run multiple quantum circuit mapping problems simultaneously, which may speed up a process of generating a quantum circuit mapping and/or allow quantum compilation service to manage quantum circuit mapping problems of multiple customers of the service provider network simultaneously. In some embodiments, different instances of RL-based quantum circuit router(s) 150 may be specifically trained for a certain set and/or subset of qubit technologies. For example, a first RL-based quantum circuit routing instance 150 may be trained using training scenarios that pertain to annealing-based quantum hardware devices, and may be configured to generate compiled instructions for executing logical quantum circuits using quantum hardware devices of quantum hardware provider 124. In another example, a second RL-based quantum circuit routing instance 150 may be trained using other training scenarios that pertain to superconducting-based quantum hardware devices, and may be configured to generate compiled instructions for executing logical quantum circuits using quantum hardware devices of quantum hardware provider 128.

Quantum compilation service 134 may also orchestrate and/or coordinate the execution of a given quantum circuit mapping problem. For example, quantum compilation service 134 may request certain compute resources (e.g., compute instances such as RL-based quantum circuit router(s) 150 and/or compute instances within service provider network 100), a time allocation on said compute resources, etc. in order to enable solving of the quantum circuit mapping problem. Furthermore, quantum compilation service 134 may additionally communicate with optimization problem service 144 within service provider network 100 and/or optimization problem service 142, accessible via service provider network 100, in order to coordinate the execution of additional aspects of a given quantum compilation problem requested by a customer of service provider network 100. Optimization problem service 142 and/or 144 may be configured to execute additional optimization problems (see translation module 180, gate nativization module 182, etc.) that pertain to quantum compilation services. Furthermore, in some embodiments, one or more instances of Monte Carlo Tree Search algorithm 152 and/or other simulation techniques may be located within optimization problem service 142 and/or 144 and quantum compilation service 134 may be configured to coordinate the use of such resources in order to further aid RL-based quantum circuit router(s) 150.

In some embodiments, quantum compilation service 134 may be configured to communicate with one or more other optimization problem services accessible via service provider network 100, such as optimization problem service 142, in which the optimization problem service may be located at a premises outside of service provider network 100. In such embodiments, quantum compilation service 134 may communicate with optimization problem service 142 via an edge computing device physically located at a premises of optimization problem service 142 such that service provider network 100 may be extended.

Quantum compilation service 134 may also include one or more additional modules (e.g., other compilation modules 138). For example, translation module 180 may be configured to translate non-Clifford operations of a logical quantum circuit into a series of Clifford operations, and/or be configured to perform one or more other intermediate translations pertaining to a target quantum hardware provider. In another example, some two-qubit gates of a logical quantum circuit may be decomposed into a series of native gates, and gate nativization module 182 may be configured to treat such decompositions. In yet another example, in some embodiments in which a quantum hardware provider of quantum hardware providers 124-130 pertains to Rydberg atom arrays, other compilation modules 138 may include a module configured to compile and/or encode a mapping problem for determining atomic computational positions in Rydberg atom arrays, according to some embodiments.

Service provider network 100 also includes quantum computing service 102. In some embodiments, a quantum computing service 102 may include a quality of service (QoS) and out-of-band prioritization module 110, a quantum algorithm development kit 116, a translation module 114, and a quantum compute simulator using classical hardware 120. Also, quantum computing service 102 is connected to quantum hardware providers 124, 126, 128, and 130. In some embodiments, quantum hardware providers 124, 126, 128, and 130 may offer access to run quantum objects on quantum computers that operate based on various different types of quantum computing technologies or paradigms, such as based on quantum annealing, ion-trap, superconductive materials, photons, etc.

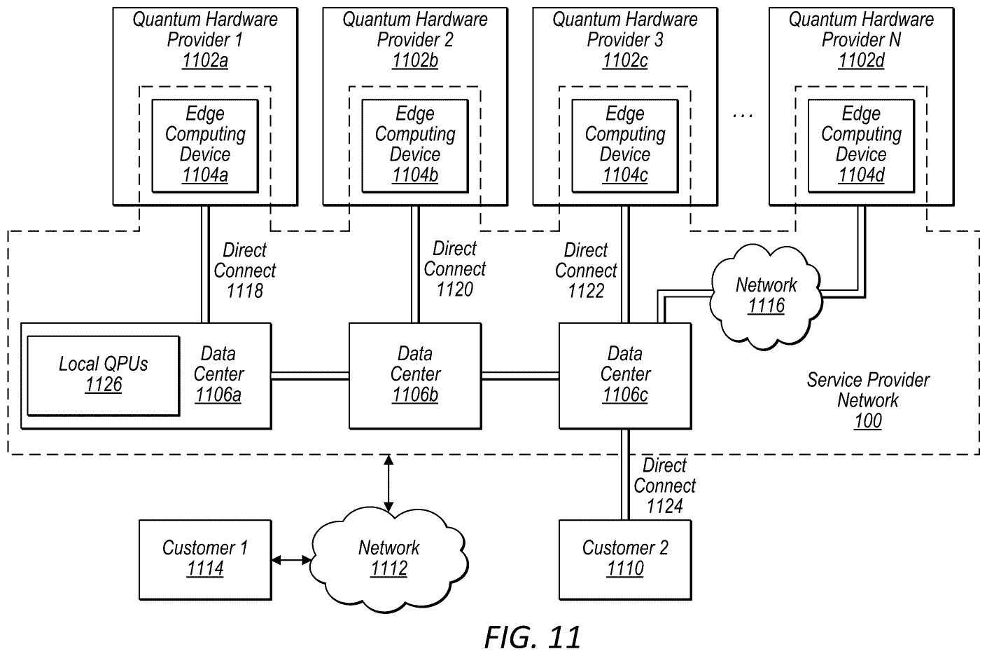

As discussed in additional detail in FIG. 11, in some embodiments, a service provider network 100 may be extended to include one or more edge computing devices physically located at quantum hardware provider locations, such as in a facility of quantum hardware providers 124, 126, 128, and 130. Physically locating (e.g., co-locating) an edge computing device of a service provider network 100 on premises at a quantum hardware provider facility may extend data security and encryption of the service provider network 100 into the quantum hardware providers 124, 126, 128, and 130 facilities, thus ensuring the security of customer data. Also, physically locating an edge computing device of a service provider network 100 on premises at a quantum hardware provider facility may reduce latency between a compute instance of the service provider network and a quantum computer located at the quantum hardware provider facility. Thus, some applications, such as hybrid algorithms that are sensitive to network latencies may be performed by quantum computing service 102, whereas other systems without co-located classical compute capacity at a hardware provider location may have too high of latencies to perform such hybrid algorithms efficiently.

In some embodiments, quantum computing service 102 includes one or more back-end API transport modules 112. In some embodiments, a back-end API transport module 110 may be primarily implemented on edge computing devices of the quantum computing service that are located at the quantum hardware provider locations (such as edge computing devices 1104a, 1104b, 1104c, and 1104d illustrated in FIG. 11). Also, in some embodiments, at least some of the back-end API transport functionality may be implemented on the one or more computing devices of the service provider network that implement the quantum computing service (such as computing devices in data center 1106a, 1106b, 1106c illustrated in FIG. 11). In some embodiments, different quantum hardware providers may require different back-end API transport modules, which may further add variability to execution durations of quantum tasks. Some quantum hardware providers may accept quantum tasks over a network via an API such that it is not necessary for the provider network to locate an edge computing device at the quantum hardware provider's facility in order to submit quantum tasks. In some embodiments, some quantum hardware providers may follow a first in first out (FIFO) execution model for quantum tasks submitted for execution to the quantum hardware provider. Other quantum hardware providers may follow a batch execution model. In order to deal with these execution duration variabilities and to further deal with execution duration variability due to characteristics of various quantum tasks (e.g. number of shots, quantum circuit size, number of gates, time to switch between quantum circuits, etc.), a priority access control plane may order quantum tasks submitted to the back-end API transports for various quantum hardware providers in a prioritized order such that quality of service (QOS) guarantees and other scheduling rules are followed.

Quantum computing service 102 is also configured to translate a given quantum computing object into a selected quantum circuit format for a particular quantum computing technology used by the selected quantum hardware provider or internal QPU, wherein the selected quantum circuit format for the particular quantum computing technology is one of a plurality of quantum circuit formats for a plurality of different quantum computing technologies supported by the quantum computing service. To translate the quantum computing object into the selected quantum circuit format, the one or more computing devices that implement the quantum computing service are configured to identify portions of the quantum computing object corresponding to quantum operators in an intermediate representation in which the quantum object was submitted by the customer, substitute the quantum operators of the intermediate representation with quantum operators of the quantum circuit format of the particular quantum computing technology, and perform one or more optimizations to reduce an overall number of quantum operators in a translated quantum circuit that is a translated version of the received quantum computing object. Additionally, quantum computing service 102 may be configured to provide the translated quantum circuit for execution at a quantum hardware provider or internal QPU that uses the particular quantum computing technology; receive, from the quantum hardware provider or internal QPU, results of the execution of the translated quantum circuit; and provide a notification to a customer of the quantum computing service that the quantum computing object has been executed.

Quantum circuits that have been translated by translation module 114 may be provided to back-end API transport module 112 in order for the translated quantum circuits to be transported to a quantum computer at a respective quantum hardware provider location. In some embodiments, back-end API transport 112 may be a non-public API that is accessible by an edge computing device of service provider network 100, but that is not publicly available. In some embodiments, a quality of service (QOS) and out-of-band prioritization module 110 may manage which quantum tasks are submitted to the back-end API transport and in what order. In some embodiments, edge computing devices at the quantum hardware providers 124, 126, 128, and 130 may periodically ping a quantum computer service side interface to the back-end API transport 112 to determine if there are any quantum circuits (or batches of quantum circuits) waiting to be transported to the edge computing device. If so, the edge computing device may perform an API call to the back-end API transport 112 to cause the quantum circuit to be transported over a private connection to the edge computing device and scheduled for execution on a quantum computer. Also, the edge computing device may have been configured with a quantum machine image that enables the edge computing device to interface with a scheduling application of the quantum hardware provider, where the edge computing device is located, in order to schedule a time slot on the quantum computer of the quantum hardware provider to execute the quantum circuit via the back-end API transport 112.

In some embodiments, results of executing the quantum circuit on the quantum computer at the quantum hardware provider location may be returned to the edge computing device at the quantum hardware provider location. The edge computing device and/or quantum computing service 102 may cause the results to be stored in a data storage system of the service provider network 100. In some embodiments, results storage/results notification module 118 may coordinate storing results and may notify a customer, such as customer 104, that the results are ready from the execution of the customer's quantum object, such as a quantum task, quantum algorithm, or quantum circuit. In some embodiments, results storage/results notification module 118 may cause storage space in a data storage service to be allocated to a customer to store the customer's results. Also, the results storage/results notification module 118 may specify access restrictions for viewing the customer's results in accordance with customer preferences.

In some embodiments, quantum compute simulator using classical hardware 120 of quantum computing service 102 may be used to simulate a quantum algorithm or quantum circuit using classical hardware. For example, one or more virtual machines of a virtual computing service may be instantiated to process a quantum algorithm or quantum circuit simulation job. In some embodiments, quantum compute simulator using classical hardware 120 may fully manage compute instances that perform quantum circuit simulation. For example, in some embodiments, a customer may submit a quantum circuit to be simulated and quantum compute simulator using classical hardware 120 may determine resources needed to perform the simulation job, reserve the resources, configure the resources, etc. In some embodiments, quantum compute simulator using classical hardware 120 may include one or more “warm” simulators that are pre-configured simulators such that they are ready to perform a simulation job without a delay typically involved in reserving resources and configuring the resources to perform simulation.

In some embodiments, quantum computing service 102 includes quantum hardware provider recommendation/selection module 122. In some embodiments, quantum hardware recommendation/selection module 122 may make a recommendation to a quantum computing service customer as to which type of quantum computer or which quantum hardware provider to use to execute a quantum object submitted by the customer. Additionally, or alternatively, the quantum hardware provider recommendation/selection module 122 may receive a customer selection of a quantum computer type and/or quantum hardware provider to use to execute the customer's quantum object, such as a quantum task, quantum algorithm, quantum circuit, etc. submitted by the customer or otherwise defined with customer input. In some embodiments, the recommendation may include estimated costs, error rates, run-times, etc. associated with executing the quantum computing object on quantum computers of respective ones of the quantum hardware providers or an internal QPU.

In some embodiments, a recommendation provided by quantum hardware provider recommendation/selection module 122 may be based on one or more characteristics of a quantum object submitted by a customer and one or more characteristics of the quantum hardware providers supported by the quantum computing service 102, such as one or more of quantum hardware providers 124, 126, 128, or 130.

In some embodiments, quantum hardware provider recommendation/selection module may make a recommendation based on known data about previously executed quantum objects similar to the quantum object submitted by the customer. For example, quantum computing service 102 may store certain amounts of metadata about executed quantum objects and use such metadata to make recommendations. In some embodiments, a recommendation may include an estimated cost to perform the quantum computing task by each of the first and second quantum hardware providers. In some embodiments, a recommendation may include an estimated error rate for each of the first and second quantum hardware providers in regard to performing the quantum computing task. In some embodiments, a recommendation may include an estimated length of time to execute the quantum computing task for each of the first and second quantum hardware providers. In some embodiments, a recommendation may include various other types of information relating to one or more quantum hardware providers or any combination of the above.

In some embodiments, quantum compute simulator using classical hardware 120 may allow a customer to simulate one or more particular quantum computing technology environments. For example, a customer may simulate a quantum circuit in an annealing quantum computing environment and an ion trap quantum computing environment to determine simulated error rates. The customer may then use this information to make a selection of a quantum hardware provider to use to execute the customer's quantum circuit.

### Applying a Reinforcement-Learning-Based (RL-Based) Quantum Circuit Router for Use in Solving Quantum Circuit Mapping Problems

The following figures (FIGS. 3-8C) provide example embodiments of how an RL-based quantum circuit router may be used to solve for a quantum circuit mapping problem, including example quantum circuit mapping problems (e.g., FIGS. 3-5), example “playthrough” scenarios of said problems (e.g., FIGS. 6A, 6B, 7A-7C, 8A, and 8B), and example applications of a Monte Carlo Tree Search (e.g., FIGS. 6C, 7D, and 8C). A person having ordinary skill in the art should understand that the following example embodiments are meant to demonstrate possible configurations of the methods and apparatus described herein and are not meant to be restrictive.

FIG. 3 illustrates a series of inputs that may be provided to an RL-based quantum circuit router during a quantum circuit mapping request, according to some embodiments.

In some embodiments, quantum circuit mapping requests received via quantum compilation service 134 may resemble quantum circuit mapping request 300, 400, and/or 500. As shown in FIGS. 3, 4, and 5, a quantum circuit mapping request may include a physical qubit connectivity graph (or equivalent information about connectivity of a given quantum hardware device), a logical quantum circuit (or equivalent information about logical qubits and gate dependencies of the given logical quantum circuit), and an allocation scheme between logical qubits of the logical quantum circuit and physical qubits of the quantum hardware device.

For example, in some embodiments, a description of physical qubit placements and respective connectivities to one another for a given quantum hardware device may resemble physical qubit connectivity graph 320. A person having ordinary skill in the art should understand that physical qubit connectivity graph 320 is used herein as an example, and that physical qubit connectivity graphs corresponding to other quantum hardware devices (e.g., quantum hardware devices provided by quantum hardware providers 124, 126, 128, 130, etc.) may include additional or less physical qubits than the three physical qubits shown in physical qubit connectivity graph 320, and/or may be connected via edges that are placed in configurations other than that which is shown in physical qubit connectivity graph 320. Physical qubit connectivity graphs 320, 420, and 520 are meant to be illustrative for the methods and techniques described herein.

In some embodiments, physical qubit connectivity graph 320 includes three physical qubits (e.g., physical qubits 301, 302, and 303), wherein physical qubits 301 and 302 are physically connected via edge e₁, and physical qubits 301 and 303 are physically connected via edge e₂. In some embodiments, physical qubit connectivity graph 320 may be described via a list of the physical qubits (e.g., Physical qubits list: {q₃₀₁, q₃₀₂, q₃₀₃}) and a list of edges that physically connect respective ones of the physical qubits (e.g., Edges list: ({e₁, e₂}), which may, in turn, be used in order to complete a given qubit allocation (e.g., qubit allocation 360).

In some embodiments, it may be implicitly understood via physical qubit connectivity graph 320 that the following two-qubit gates may be performed according to the physical layout of the given quantum hardware device represented by physical qubit connectivity graph 300: a two-qubit gate between physical qubits 301 and 302, and a two-qubit gate between physical qubits 301 and 303. Similarly, the following two-qubit gate may not be (directly) performed according to the physical layout represented by physical qubit connectivity graph 320: a two-qubit gate between physical qubits 302 and 303. If a given logical quantum circuit calls for a two-qubit gate between physical qubits 301 and 303 to be performed, a SWAP gate or another similar method may be used so as to logically alter the states of two given physical qubits of qubits 301, 302, and 303 in order to perform said gate. In some embodiments, the above explanation of a physical qubit connectivity graph may be used in preparation for submitting a given quantum circuit mapping problem to an RL-based quantum circuit router.

In some embodiments, a logical quantum circuit which is to be mapped for execution using a given quantum hardware device may resemble logical quantum circuit 340. A person having ordinary skill in the art should understand that logical quantum circuit 340 is used herein as an example, and that logical quantum circuits corresponding to other logical quantum computations may include additional or less logical qubits than the three logical qubits shown in logical quantum circuit 340, and/or may include additional and/or other single or multi-qubit gates other than the three two-qubit gates which are shown in logical quantum circuit 340.

In some embodiments, logical quantum circuit 340 details three two-qubit gates that are to be performed between respective ones of the three logical qubits shown in the figure in order to complete a given quantum computation. In some embodiments, logical quantum circuit 340 may be described via a list of logical qubits (e.g., Logical qubits list: {A, B, C}) and a list of gates that are to be performed between respective ones of said logical qubits (e.g., Gates list: {g₀, g₁, g₂}), which may, in turn, be used in order to complete a given qubit allocation (e.g., qubit allocation 360). A gate dependency list may additionally be used to describe logical quantum circuit 340 in which, according to logical quantum circuit 340, gate g₀ must be performed on logical qubit A before gate g₁ is performed on logical qubit A, etc. Such a gate dependency list may be generated by enumerating gate dependencies on each logical qubit (e.g., {A, B, C}= {(g₀, g₁), (g₀, g₂), (g₁, g₂)}). Such initializations of a given logical quantum circuit (and of a physical qubit connectivity graph as described above) be viewed as an initialization step and/or a pre-processing step performed by quantum compilation service 134 in preparation for submitting the given quantum circuit mapping request an RL-based quantum circuit router.

In some embodiments, logical qubits of logical quantum circuit 340 may be assigned to one or more physical qubits of physical qubit connectivity graph 320, and such an assignment may resemble qubit allocation 360. An initial qubit allocation may be used when routing quantum gates of logical quantum circuit 340 for execution using physical qubit connectivity graph 320, and an initial qubit allocation may represent such a logical to physical qubit assignment prior to an RL-based quantum circuit router scheduling SWAP gates. After an RL-based quantum circuit router has scheduled a SWAP gate, such a logical to physical qubit assignment may be referred to herein as an intermediate qubit allocation, as one or more components of the assignment have been changed in response to the scheduled SWAP gate, according to some embodiments. As shown in FIG. 3, initial qubit allocation 360 considers an initial logical [symbol] physical qubit assignment of {A [symbol] q₃₀₁,B [symbol] q₃₀₂,C [symbol] q₃₀₃}.

FIG. 4 illustrates another series of inputs that may be provided to an RL-based quantum circuit router during another quantum circuit mapping request, according to some embodiments.

In some embodiments, various quantum circuit mapping requests may include a similar physical qubit connectivity graph, such as physical qubit connectivity graphs 320 and 420 in FIGS. 3 and 4. For example, physical qubit connectivity graphs 320 and 420 may represent a given quantum hardware device at quantum hardware provider 124, 126, 128, or 130, and multiple logical quantum circuits (e.g., logical quantum circuits 340, 440, etc.) from one or more customers of service provider network 100 may be mapped for execution using the given quantum hardware device. In another example, an RL-based quantum circuit router may be trained using a similar physical qubit connectivity graph and a series of different logical quantum circuits such that the RL-based quantum circuit router may improve its ability to map logical quantum circuits to quantum hardware devices of a given qubit topology, qubit technology, etc.

In some embodiments, physical qubit connectivity graph 420 includes three physical qubits (e.g., physical qubits 401, 402, and 403), wherein physical qubits 401 and 402 are physically connected via edge e₁, and physical qubits 401 and 403 are physically connected via edge e₂. In some embodiments, physical qubit connectivity graph 420 may be described via a list of the physical qubits (e.g., Physical qubits list: {9401, 9402, 9403}) and a list of edges that physically connect respective ones of the physical qubits (e.g., Edges list: ({e₁, e₂}), which may, in turn, be used in order to complete a given qubit allocation (e.g., qubit allocation 460).

In some embodiments, logical quantum circuit 440 details three two-qubit gates that are to be performed between respective ones of the three logical qubits shown in the figure in order to complete a given quantum computation. In some embodiments, logical quantum circuit 440 may be described via a list of logical qubits (e.g., Logical qubits list: {A, B, C}) and a list of gates that are to be performed between respective ones of said logical qubits (e.g., Gates list: {g₀, g₁, g₂}), which may, in turn, be used in order to complete a given qubit allocation (e.g., qubit allocation 460). A gate dependency list may additionally be used to describe logical quantum circuit 440 in which, according to logical quantum circuit 440, gate g₀ must be performed on logical qubit A before gate g₂ is performed on logical qubit A, etc. Such a gate dependency list may be generated by enumerating gate dependencies on each logical qubit (e.g., {A, B, C}= {(g₀, g₂), (g₀, g₁), (g₁,g₂)}). Such initializations of a given logical quantum circuit (and of a physical qubit connectivity graph as described above) be viewed as an initialization step and/or a pre-processing step performed by quantum compilation service 134 in preparation for submitting the given quantum circuit mapping request an RL-based quantum circuit router.

As shown in FIG. 4, initial qubit allocation 460 considers an initial logical [symbol] physical qubit assignment of {A [symbol] q₄₀₁,B [symbol] q₄₀₂,C [symbol] q₄₀₃}.

FIG. 5 illustrates yet another series of inputs that may be provided to an RL-based quantum circuit router during yet another quantum circuit mapping request, according to some embodiments.

As shown in FIG. 5, quantum circuit mapping request 500 includes both a different physical qubit connectivity graph and a different logical quantum circuit than in quantum circuit mapping requests 300 and 400 described above. In some embodiments, a given RL-based quantum circuit routing instance may be trained on more than one quantum hardware device layout of a given quantum hardware provider (e.g., physical qubit connectivity graph 420 vs physical qubit connectivity graph 520). In other embodiments, a first RL-based quantum circuit routing instance may be configured to solve quantum circuit mapping problems using physical qubit connectivity graph 420, and a second RL-based quantum circuit routing instance may be configured to solve quantum circuit mapping problems using physical qubit connectivity graph 520 (e.g., in embodiments in which physical qubit connectivity graph 420 and physical qubit connectivity graph 520 represent layouts based on different qubit technologies and/or topologies corresponding to different quantum hardware providers).

In some embodiments, physical qubit connectivity graph 520 includes four physical qubits (e.g., physical qubits 501, 502, 503, and 504), wherein physical qubits 501 and 502 are physically connected via edge e₁, physical qubits 502 and 503 are physically connected via edge e₂, and physical qubits 502 and 504 are physically connected via edge e₃. In some embodiments, physical qubit connectivity graph 520 may be described via a list of the physical qubits (e.g., Physical qubits list: {q₅₀₁, q₅₀₂, q₅₀₃, q₅₀₄}) and a list of edges that physically connect respective ones of the physical qubits (e.g., Edges list: ({e₁, e₂, e₃}), which may, in turn, be used in order to complete a given qubit allocation (e.g., qubit allocation 560).

In some embodiments, logical quantum circuit 540 details three two-qubit gates that are to be performed between respective ones of the four logical qubits shown in the figure in order to complete a given quantum computation. In some embodiments, logical quantum circuit 540 may be described via a list of logical qubits (e.g., Logical qubits list: {A, B, C, D}) and a list of gates that are to be performed between respective ones of said logical qubits (e.g., Gates list: {g₀, g₁, g₂}), which may, in turn, be used in order to complete a given qubit allocation (e.g., qubit allocation 560). A gate dependency list may additionally be used to describe logical quantum circuit 540 in which, according to logical quantum circuit 540, gate g₀ must be performed on logical qubit B before gate g₁ is performed on logical qubit B, etc. Such a gate dependency list may be generated by enumerating gate dependencies on each logical qubit (e.g., {A, B, C, D}= {(g₀), (g₀, g₁), (g₁, g₂), (g₂)}). Such initializations of a given logical quantum circuit (and of a physical qubit connectivity graph as described above) be viewed as an initialization step and/or a pre-processing step performed by quantum compilation service 134 in preparation for submitting the given quantum circuit mapping request an RL-based quantum circuit router.

As shown in FIG. 5, initial qubit allocation 560 considers an initial logical [symbol] physical qubit assignment of {A [symbol] q₅₀₁,B [symbol] q₅₀₂,C [symbol] q₅₀₃, D [symbol] q₅₀₄}.

FIGS. 6A and 6B illustrate possible playthrough scenarios of the quantum circuit mapping request described in FIG. 3, and FIG. 6C illustrates a Monte Carlo Tree Search (MCTS) diagram of the quantum circuit mapping request described in FIG. 3, according to some embodiments.

FIGS. 6A and 6B demonstrate two different routing results for quantum circuit mapping request 300. As shown in FIGS. 6A and 6B, quantum circuit routing results 620 and 640 consider an initial logical [symbol] physical qubit allocation of {A [symbol] q₃₀₁, B [symbol] q₃₀₂, C [symbol] q₃₀₃} (see also qubit allocation 360 shown in FIG. 3) which may be applied in order to schedule performance of gates g₀ and g₁ prior to the first scheduling of a SWAP gate (and prior to the scheduling of gate g₂). In some embodiments, a current state of the environment (e.g., a current state in solving quantum circuit mapping request 300), as interpreted via agent 156, may resemble information that:
gates g₀ and g₁ have been scheduled for execution,
gate g₂ has not yet been successfully scheduled for execution,
zero SWAP gates have been scheduled for execution, and that
the current qubit allocation scheme in use is qubit allocation scheme 360. In some embodiments, such information may be provided as new experience 204 as shown in FIG. 2A.

Given the configuration of qubit allocation 360, however, it may not currently be possible to schedule gate g₂, and therefore agent 156 may select an action that causes a SWAP gate to be scheduled, as shown in FIGS. 6A and 6B, respectively. In some embodiments, policy network 154 may use Monte Carlo Tree Search (MCTS) 152 to forecast projected outcomes of various SWAP gates that may be scheduled between respective sets of logical qubits of logical quantum circuit 340. In some embodiments, such a forecasting via MCTS 152 may visually resemble MCTS 650, wherein there are two possible SWAP gate combinations, given the configuration of physical qubit connectivity graph 320. Given the conditions shown in MCTS 650, there are two “pathways” to succeeding in scheduling gate g₂, and therefore succeeding in scheduling all quantum gates of logical quantum circuit 340, and both of which have been nicknamed “victory” in FIG. 6C: scheduling a SWAP gate between logical qubits A and B, and scheduling a SWAP gate between logical qubits A and C.

As shown in quantum circuit routing result 620, if agent 156 selects an action to schedule a SWAP gate between logical qubits A and B (e.g., action selection 204 as shown in FIG. 2A), the current qubit allocation scheme in use may be updated to {B [symbol] q₃₀₁, A [symbol] q₃₀₂, C [symbol] q₃₀₃}, allowing gate g₂ to be scheduled. A reflection of this updated qubit allocation scheme is visually represented in logical interpretation of intermediate allocations 610. However, a person having ordinary skill in the art should understand that logical interpretation of intermediate allocations 610 (and logical interpretation of intermediate allocations 630 discussed below) is meant to convey a visual representation of the given updated qubit allocation scheme and is meant to aid the reader in understanding FIGS. 6A and 6B. It does not represent any physical change to physical qubit connectivity graph 320. Furthermore, an updated current state of the environment (see also update state 206 in FIG. 2A), based on agent 156 selecting an action to schedule a SWAP gate between logical qubits A and B, may then resemble information that:
gates g₀, g₁, and g₂ have been scheduled for execution,
one SWAP gate has been scheduled for execution, and that
the current qubit allocation scheme in use is {B [symbol] q₃₀₁, A [symbol] q₃₀₂, C [symbol] q₃₀₃}.

Alternatively, and as shown in quantum circuit routing result 640, if agent 156 selects an action to schedule a SWAP gate between logical qubits A and C, the current qubit allocation scheme in use may be updated to {C [symbol] q₃₀₁, B [symbol] q₃₀₂, A [symbol] q₃₀₃}, allowing gate g₂ to be scheduled. Furthermore, an updated current state of the environment, as interpreted via agent 156, may then resemble information that:
gates g₀, g₁, and g₂ have been scheduled for execution,
one SWAP gate has been scheduled for execution, and that.
the current qubit allocation scheme in use is {C [symbol] q₃₀₁, B [symbol] q₃₀₂, A [symbol] q₃₀₃}.

A person having ordinary skill in the art should understand that quantum circuit routing results 620 and 640 represent possible solutions to quantum circuit mapping request 300, and that additional solutions may also exist and are meant to be encompassed in the discussion herein. Furthermore, FIGS. 6A and 6B resemble visual representations to possible quantum circuit routing results that may be generated via reinforcement learning training model 200, according to some embodiments. Results to quantum circuit mapping request 300 may additionally or alternatively resemble compiled instructions and/or any other equivalent method of portraying information shown in FIGS. 6A and 6B (see also description pertaining to block 918 herein).

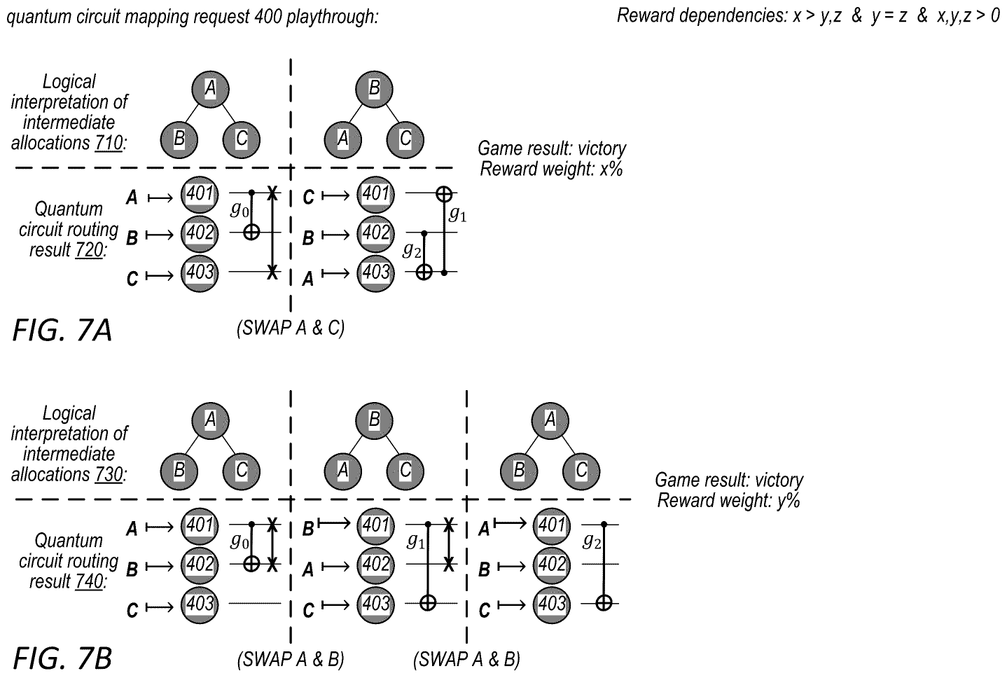

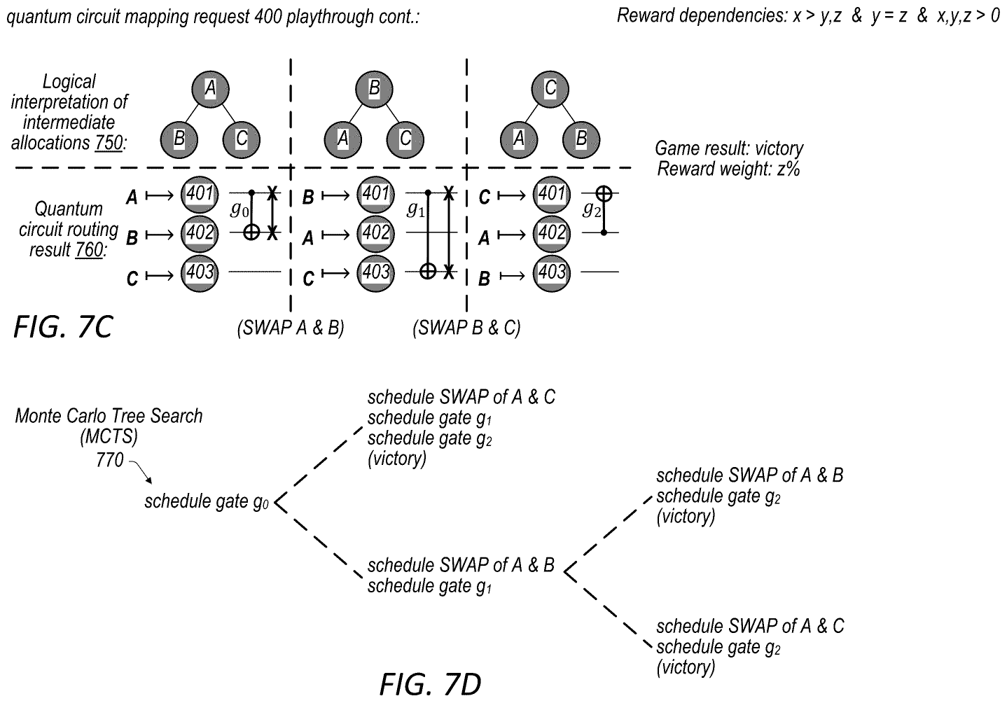

In some embodiments, following a selection of an action, one or more rewards and/or reward weight dependencies may be updated (see also determine loss values 206 in FIG. 2A). For example, based on the two forecasted pathways shown in MCTS 650, an equal weighting of reward for selecting the action to schedule a SWAP gate between logical qubits A and B or the action to schedule a SWAP gate between logical qubits A and C may be determined via value network 158 (e.g., reward dependencies: x=y) since both actions lead to a successful routing of quantum circuit mapping request 300 in a total of one action. In another example, and as described below with regard to FIG. 7D, unequal weightings of rewards may be determined for various pathways that result in scheduling more/less SWAP gates with respect to other pathways, etc. A person having ordinary skill in the art should understand that one or more reward dependencies may be updated after scheduling any number of actions selected via agent 156, and that the discussion above of updating rewards following the selection of one action is not meant to be restrictive.

FIGS. 7A, 7B, and 7C illustrate possible playthrough scenarios of the quantum circuit mapping request described in FIG. 4, and FIG. 7D illustrates a Monte Carlo Tree Search (MCTS) diagram of the quantum circuit mapping request described in FIG. 4, according to some embodiments.

FIGS. 7A, 7B, and 7C demonstrate three different routing results for quantum circuit mapping request 400. As shown in FIGS. 7A, 7B, and 7C, quantum circuit routing results 720, 740, and 760 consider an initial logical [symbol] physical qubit allocation of {A [symbol] q₄₀₁, B [symbol] q₄₀₂, C [symbol] q₄₀₃} (see also qubit allocation 460 shown in FIG. 4) which may be applied in order to schedule performance of gate g₀ prior to the first scheduling of a SWAP gate (and prior to the scheduling of gates g₁ and g₂). In some embodiments, a current state of the environment (e.g., a current state in solving quantum circuit mapping request 400), as interpreted via agent 156, may resemble information that:
gate g₀ has been scheduled for execution,
gates g₁ and g₂ have not yet been successfully scheduled for execution,
zero SWAP gates have been scheduled for execution, and that
the current qubit allocation scheme in use is qubit allocation scheme 460.

Given the configuration of qubit allocation 460, however, it may not currently be possible to schedule gates g₁ and g₂, and therefore agent 156 may select an action that causes a SWAP gate to be scheduled, as shown in FIGS. 7A, 7B, and 7C, respectively. As shown in MCTS 770, there are two possible SWAP gate combinations, given the configuration of physical qubit connectivity graph 420. Given the conditions shown in MCTS 770, there are two pathways to succeeding in scheduling gate g₁, while one of the two pathways further leads to success in scheduling all quantum gates of logical quantum circuit 440 within the selection of the same one action.

As shown in quantum circuit routing result 720, if agent 156 selects an action to schedule a SWAP gate between logical qubits A and C, the current qubit allocation scheme in use may be updated to {C [symbol] q₄₀₁, B [symbol] q₄₀₂, A [symbol] q₄₀₃}, allowing gates g₁ and g₂ to be scheduled. A reflection of this updated qubit allocation scheme is visually represented in logical interpretation of intermediate allocations 710. Furthermore, an updated current state of the environment, based on agent 156 selecting an action to schedule a SWAP gate between logical qubits A and C, may then resemble information that:
gates g₀, g₁, and g₂ have been scheduled for execution,
one SWAP gate has been scheduled for execution, and that
the current qubit allocation scheme in use is {C [symbol] q₄₀₁, B [symbol] q₄₀₂, A [symbol] q₄₀₃}.

Alternatively, and as shown in quantum circuit routing results 740 and 760, if agent 156 selects an action to schedule a SWAP gate between logical qubits A and B, the current qubit allocation scheme in use may be updated to {B [symbol] q₄₀₁, A [symbol] q₄₀₂, C [symbol] q₄₀₃}, allowing gate g₁ to be scheduled. A reflection of this updated qubit allocation scheme is visually represented in logical interpretation of intermediate allocations 730 and 750. Furthermore, an updated current state of the environment, as interpreted via agent 156, may then resemble information that:
gates g₀ and g₁ have been scheduled for execution,
one SWAP gate has been scheduled for execution, and that.
the current qubit allocation scheme in use is {B [symbol] q₄₀₁, A [symbol] q₄₀₂, C [symbol] q₄₀₃}.

From said updated current state of the environment, there are two pathways to succeeding in scheduling gate g₂. In a first pathway, agent 156 selects an action to schedule a SWAP gate between logical qubits A and B (see FIG. 7B), and the current qubit allocation scheme in use may be again updated to {A [symbol] q₄₀₁, B [symbol] q₄₀₂, C [symbol] q₄₀₃}, allowing gate g₂ to be scheduled. In a second pathway, agent 156 selects an action to schedule a SWAP gate between logical qubits B and C (see FIG. 7C), and the current qubit allocation scheme in use may be alternatively updated to {C [symbol] q₄₀₁, A [symbol] q₄₀₂, B [symbol] q₄₀₃}, allowing gate g₂ to be scheduled. Furthermore, an additionally updated current state of the environment, as interpreted via agent 156, may then resemble information that:
gates g₀, g₁, and g₂ have been scheduled for execution,
two SWAP gates have been scheduled for execution, and that
the current qubit allocation scheme in use is {A [symbol] q₄₀₁, B [symbol] q₄₀₂, C [symbol] q₄₀₃} in the case of the first pathway, or {C [symbol] q₄₀₁, A [symbol] q₄₀₂, B [symbol] q₄₀₃} in the case of the second pathway.

In some embodiments, one or more rewards and/or reward dependencies may be updated following selection of action(s) as shown in MCTS 770. For example, initially selecting an action to schedule a SWAP gate between logical qubits A and C may correspond to a higher weighted reward than initially selecting an action to schedule a SWAP gate between logical qubits A and B, as the former may lead to a successful scheduling of all quantum gates of logical quantum circuit 540 using fewer SWAP gates than the latter.

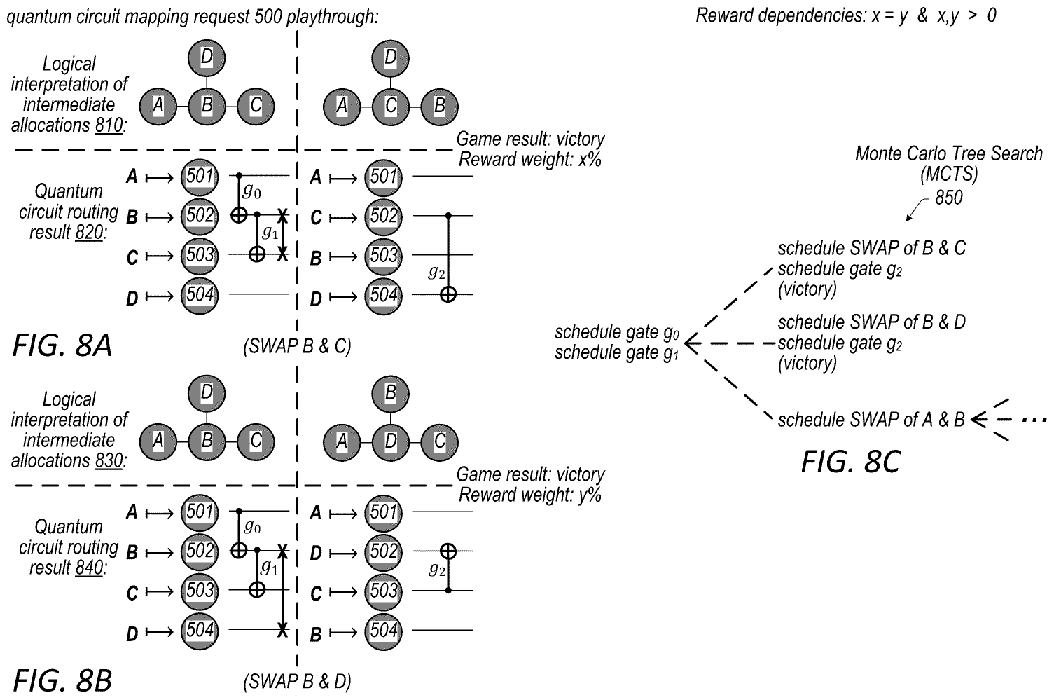

FIGS. 8A and 8B illustrate possible playthrough scenarios of the quantum circuit mapping request described in FIG. 5, and FIG. 8C illustrates a Monte Carlo Tree Search (MCTS) diagram of the quantum circuit mapping request described in FIG. 5, according to some embodiments.

FIGS. 8A and 8B demonstrate two different routing results for quantum circuit mapping request 500. As shown in FIGS. 8A and 8B, quantum circuit routing results 820 and 840 consider an initial logical [symbol] physical qubit allocation of {A [symbol] q₅₀₁, B [symbol] q₅₀₂, C [symbol] q₅₀₃, D [symbol] q₅₀₄} (see also qubit allocation 560 shown in FIG. 5) which may be applied in order to schedule performance of gates g₀ and g₁ prior to the first scheduling of a SWAP gate (and prior to the scheduling of gate g₂). In some embodiments, a current state of the environment (e.g., a current state in solving quantum circuit mapping request 500), as interpreted via agent 156, may resemble information that:
gates g₀ and g₁ have been scheduled for execution,
gate g₂ has not yet been successfully scheduled for execution,
zero SWAP gates have been scheduled for execution, and that
the current qubit allocation scheme in use is qubit allocation scheme 560.

Given the configuration of qubit allocation 560, however, it may not currently be possible to schedule gate g₂, and therefore agent 156 may select an action that causes a SWAP gate to be scheduled, as shown in FIGS. 8A and 8B, respectively. As shown in MCTS 850, there are three possible SWAP gate combinations, given the configuration of physical qubit connectivity graph 520. As shown in MCTS 850, there are two pathways to succeeding in scheduling gate g₂, and therefore succeeding in scheduling all quantum gates of logical quantum circuit 540, and one pathway that does not directly lead to success of scheduling gate g₂.

As shown in quantum circuit routing result 820, if agent 156 selects an action to schedule a SWAP gate between logical qubits B and C, the current qubit allocation scheme in use may be updated to {A [symbol] q₅₀₁, C [symbol] q₅₀₂, B [symbol] q₅₀₃, D [symbol] q₅₀₄}, allowing gate g₂ to be scheduled. A reflection of this updated qubit allocation scheme is visually represented in logical interpretation of intermediate allocations 810. Furthermore, an updated current state of the environment, based on agent 156 selecting an action to schedule a SWAP gate between logical qubits B and C, may then resemble information that:
gates g₀, g₁, and g₂ have been scheduled for execution,
one SWAP gate has been scheduled for execution, and that.
the current qubit allocation scheme in use is {A [symbol] q₅₀₁, C [symbol] q₅₀₂, B [symbol] q₅₀₃, D+q₅₀₄}.

Alternatively, and as shown in quantum circuit routing result 840, if agent 156 selects an action to schedule a SWAP gate between logical qubits B and D, the current qubit allocation scheme in use may be updated to {A [symbol] q₅₀₁, D [symbol] q₅₀₂, C [symbol] q₅₀₃, B [symbol] q₅₀₄}, allowing gate g₂ to be scheduled. A reflection of this updated qubit allocation scheme is visually represented in logical interpretation of intermediate allocations 830. Furthermore, an updated current state of the environment, as interpreted via agent 156, may then resemble information that:
gates g₀, g₁, and g₂ have been scheduled for execution,
one SWAP gate has been scheduled for execution, and that.
the current qubit allocation scheme in use is {A [symbol] q₅₀₁, D [symbol] q₅₀₂, C [symbol] q₅₀₃, B [symbol] q₅₀₄}.

Alternatively, agent 156 may select an action to schedule a SWAP gate between logical qubits A and B, and the current qubit allocation scheme in use may be updated to {B [symbol] q₅₀₁, A [symbol] q₅₀₂, C [symbol] q₅₀₃, D [symbol] q₅₀₄}, according to some embodiments. However, such an action may not (directly) lead to the allowance of gate g₂ being scheduled. In some embodiments, an additional parameter of policy network 154 may include to avoid selecting an action pertaining to a SWAP gate combination that does not directly lead to at least one quantum gate being scheduled, and agent 156 may select an action other than a SWAP gate between logical qubits A and B. However, there may be additional reasons for selecting an action to schedule a SWAP gate between logical qubits A and B. For example, RL-based quantum circuit router 150 may have access to a noise model for a particular quantum hardware device represented via physical qubit connectivity graph 520, and, due to potential crosstalk between certain physical qubits, etc., it may be advantageous to select an action to schedule a SWAP gate between logical qubits A and B. In such scenarios, agent 156 may then select an additional action of a new plurality of actions in order to proceed with attempting to schedule gate g₂.

In some embodiments, following a selection of one of the above actions, one or more reward weights and/or reward dependencies may be updated. For example, based on the forecasted pathways shown in MCTS 850, an equal weighting of reward for selecting the action to schedule a SWAP gate between logical qubits B and C or the action to schedule a SWAP gate between logical qubits B and D may be determined via value network 158 (e.g., reward dependencies: x=y) since both actions lead to a successful routing of quantum circuit mapping request 500 in a total of one action. In some embodiments, selecting the action to schedule a SWAP gate between logical qubits A and B may correspond to a reward that is weighted lower with respect to the above two actions, may correspond to no reward, or any other corresponding indication that differentiates between preferred pathways that lead to success in scheduling all quantum gates associated with quantum circuit mapping request 500 while using a lesser number of SWAP gates, and pathways that may or may not lead to success in scheduling all quantum gates, may lead to success with a higher number of SWAP gates, etc.

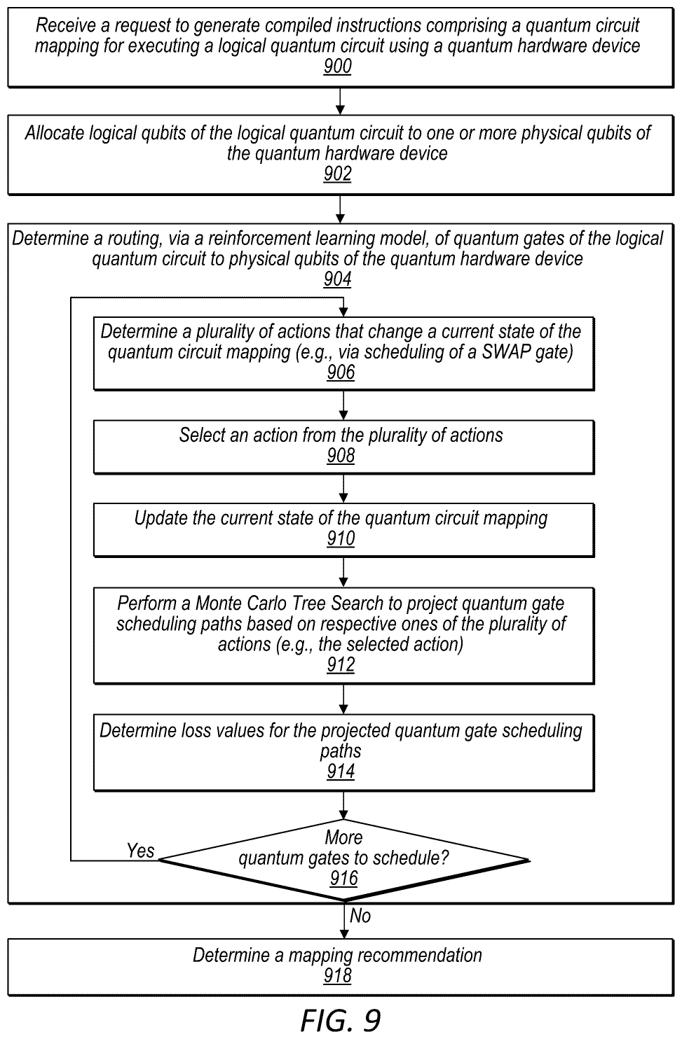

FIG. 9 is a flowchart illustrating a process of applying reinforcement learning techniques to generate compiled instructions for a quantum circuit mapping request, according to some embodiments.

In block 900, a request to generate compiled instructions including a quantum circuit mapping may be received. As described above, a quantum circuit mapping problem may include qubit allocation stage(s), described via block 902, and quantum circuit routing stage(s), described via blocks 904-916. In some embodiments, a request may be received via a customer of service provider network 100 and/or via communication with one or more services of service provider network, such as quantum computing service 102. A request may include an indication of a qubit technology, quantum hardware device, quantum hardware provider, etc. that a customer/service requests that a given logical quantum circuit to be executed using, according to some embodiments. A request may additionally include one or more logical quantum circuits that a customer/service requests to be executed. Furthermore, a request may include an initial qubit allocation scheme that a customer/service requests be used during said quantum circuit mapping. In other embodiments, quantum compilation service 134 may allocate logical qubits of a given logical quantum circuit to one or more physical qubits of the indicated quantum hardware device, as described in block 902. Such an initial allocation of logical [symbol] physical qubits may be considered to be a “pre-processing” step, prior to quantum circuit routing step(s), according to some embodiments. Examples of qubit allocation schemes are additionally described herein with regard to qubit allocations 360, 460, and 560.

In block 904, a process of determining a routing of quantum gates of a given logical quantum circuit to physical qubits of a given quantum hardware device using a reinforcement learning model (e.g., reinforcement learning training model 200) may be described via blocks 906-916. In block 906, a policy network of a reinforcement learning model (e.g., policy network 154) may determine a plurality of actions that change a current state of a quantum circuit mapping environment. In some embodiments, actions include respective schedulings of SWAP gates such that a given current qubit allocation scheme is then updated. In some embodiments, block 906 may resemble an action selection recommendation provided via policy network 154 to agent 156 of reinforcement learning training model 200. For example, prior to scheduling a first SWAP gate in quantum circuit mapping request 400, policy network 154 may provide an action selection recommendation including action options corresponding to scheduling a SWAP gate between logical qubits A and C and between logical qubits A and B. As shown in FIGS. 7A-7D, scheduling a SWAP gate between logical qubits A and C may directly lead to the scheduling of the remaining quantum gates of logical quantum circuit 440, while scheduling a SWAP gate between logical qubits A and B may lead to at least one additional action selection in order to schedule remaining quantum gates. Therefore, an action selection recommendation of policy network 154 may additionally provide probabilities that indicate that scheduling a SWAP gate between logical qubits A and C may lead to higher success in the given quantum circuit mapping determination session. Using such information, agent 156 may select the action to schedule the SWAP gate between logical qubits A and C in block 908, as this would directly lead to a successful quantum circuit mapping using a smaller number of SWAP gates by comparison. In block 910, a current state of the environment may be updated based on said action selection, and, as quantum gates g₀, g₁, and g₂ would be successfully scheduled at this point in this particular example, there are no additional quantum gates to schedule at block 914. In another example in which agent 156 selects the action to schedule the SWAP gate between logical qubits A and B, there are additional quantum gates to schedule at block 916, and a process described via blocks 906-916 may repeat, wherein an additional plurality of actions are determined at block 906, etc. Furthermore, blocks 912 and 914 may describes a process of using a Monte Carlo Tree Search to forecast one or more pathways of progression in a given quantum circuit mapping problem according to some of the plurality of actions determined in block 906. For example, a Monte Carlo Tree Search may aid policy network 154 in providing an action selection recommendation for a subsequent action to propose to agent 156 by forecasting an additional plurality of actions that may be selected based on the former selected action in block 908. In another example, a Monte Carlo Tree Search may forecast projected pathways of other unselected actions from the plurality proposed to agent 156 in block 906 in order to determine a loss and/or cost of selecting respective actions over other actions. Such a loss determination may be provided to value network 158 via determine loss values 206, as shown in FIG. 2A.

In block 918, a mapping recommendation may be determined and/or provided to a customer, wherein determining such a mapping recommendation may be considered as a “post-processing” step. In some embodiments, RL-based quantum circuit router 150 may return one, some, or all determined routing results, and said result(s) may be included in a mapping recommendation to a customer/service. In some embodiments, if RL-based quantum circuit router 150 could not determined at least one quantum circuit mapping configuration for the given request, a mapping recommendation may include an indication that a given quantum circuit mapping could not be determined given the configurations of the request. Similarly, if a quantum circuit mapping result could not be determined within a given allotted amount of time, could not be determined within the given computing constraints, etc., a mapping recommendation may indicate such limitations. In such embodiments, a mapping recommendation may indicate a different configuration of the request to re-attempt, a different qubit technology to try, etc. In some embodiments in which MCTS algorithm 152 has forecasted more than one pathway to a successful quantum circuit mapping result, a mapping recommendation may include an indication that a first pathway is preferred over a second pathway due to avoidance of crosstalk between certain physical qubits of a quantum hardware device, due to the use of a smaller number of scheduled SWAP gates, etc. A mapping recommendation may also include any additional formatting of results obtained via RL-based quantum circuit router 150, any selection of one or more results from a total number of results, any summarization of the results into “layman's terms” intended for a person not having ordinary skill in the art, etc. Such formatting of results may include generating compiled instructions based on the quantum circuit mapping results of RL-based quantum circuit router 150. For example, a “high-level” instruction to schedule a quantum gate g₀ may be replaced with “low-level” instruction(s) to initialize corresponding physical qubits, initiate pulse signal(s), and/or any instructions pertaining to a given quantum hardware device technology, etc.

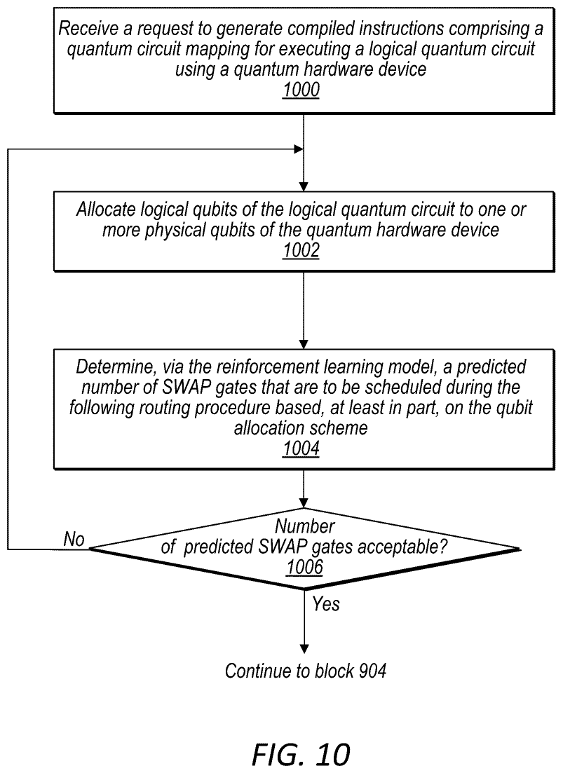

FIG. 10 is a flowchart illustrating a process of predicting results of applying reinforcement learning techniques to generate compiled instructions for a quantum circuit mapping request, according to some embodiments.

In some embodiments, RL-based quantum circuit router 150 may additionally be used to determine a predicted number of SWAP gates that may expected to be required to route quantum gates of a given logical quantum circuit to physical qubits of a given quantum hardware device. As shown in FIG. 10, blocks 1000 and 1002 resemble blocks 900 and 902 and therefore are meant to encompass their descriptions herein as well (see description pertaining to FIG. 9 herein). In block 1004, RL-based quantum circuit router 150 may be used to determine a predicted number of SWAP gates that are to be scheduled in order to successfully map the given request described in block 1000. As shown via block 1006, the predicted number of SWAP gates may be provided to a customer/service making the quantum circuit mapping request. For example, in some embodiments in which a customer has provided quantum compilation service 134 with an initial qubit allocation scheme, a prediction may be made based on said initial qubit allocation scheme. A customer may then decide to resubmit a different initial qubit allocation scheme based on determining that the predicted number of SWAP gates is high, etc., and block 1004 may be repeated based on the reallocation. Such a process described via blocks 1002, 1004, and 1006 may be repeated until a customer is satisfied with a given prediction, until an allotted time has passed, etc., at which point the process may proceed according to block 904, according to some embodiments.

FIG. 11 illustrates edge computing devices of a quantum computing service physically located at quantum hardware provider locations, according to some embodiments.

In some embodiments, service provider network 100, as illustrated in FIG. 1A, may include one or more data centers connected to each other via private or public network connections. Also, edge computing devices located at quantum hardware provider locations may be connected to a service provider network via private or public network connections. For example, service provider network 100 illustrated in FIG. 11 includes data centers 1106a, 1106b, and 1106c that are connected to one another via private physical network links of the service provider network 100. In some embodiments, a customer of the service provider network may also be connected via a private physical network link that is not available to the public to carry network traffic, such as a physical connection at a router co-location facility. For example, customer 1110 is connected to a router associated with data center 1106c via direct connection 1124. In a similar manner, edge computing devices located at quantum hardware provider locations may be connected to a service provider network via a private physical network link that is not available to carry public network traffic.

For example, edge computing device 1104a located at quantum hardware provider location 1102a is connected to a router at data center 1106a via direct connection 1118. In a similar manner, edge computing device 1104b at quantum hardware provider location 1102b is connected to a router at data center 1106b via direct connection 1120. Also, edge computing device 1104c at quantum hardware provider 1102c is connected to a router at data center 1106c via direct connection 1122.

Also, in some embodiments an edge computing device of a service provider network located at a quantum hardware provider location may be connected to the service provider network via a logically isolated network connection over a shared network connection, such as via the Internet or another public network. For example, edge computing device 1104d at quantum hardware provider location 1102d is connected to data center 1106c via a logically isolated network connection via network 1116. In a similar manner, in some embodiments a customer, such as customer 1114, may be connected to service provider network 100 via public network 1112.

In some embodiments, similar configurations may exist between quantum compilation service 134 and optimization problem service 142. For example, quantum compilation service 134 may be connected to optimization problem service 142 by using a logically isolated network connection via a public network, or by using a dedicated physical non-public network link. In some embodiments, another edge computing device may be placed at a premises of optimization problem service 142 such that quantum compilation service 134 may be connected to optimization problem service 142 via an edge computing device.

In some embodiments, a quantum computing service such as quantum computing service 102, may be implemented using one or more computing devices in any of data centers 1106a, 1106b, 1106c, etc. Also, quantum computing service 102 may provide customers, such as customer 1114 or customer 1110, access to quantum computers in any of quantum hardware provider locations 1102a, 1102b, 1102c, 1102d, etc. For example, a customer may not be restricted to using a quantum hardware provider in a local region where the customer is located. Instead, the customer may be allocated compute instances instantiated on a local edge computing device located at a selected quantum hardware provider location, such that the location of the customer does not restrict the customer's access to various types of quantum computing technology-based quantum computers.

In some embodiments, one or more of the data centers 1106 may also include local quantum hardware devices, such as local QPUs 1126. One or more of data centers 1106 may also include a local optimization problem service, such as optimization problem service 144 in which one or more computing devices at data centers 1106 are configured to perform various optimization solving techniques.

### Example Edge Computing Device Located at a Quantum Hardware Provider Location

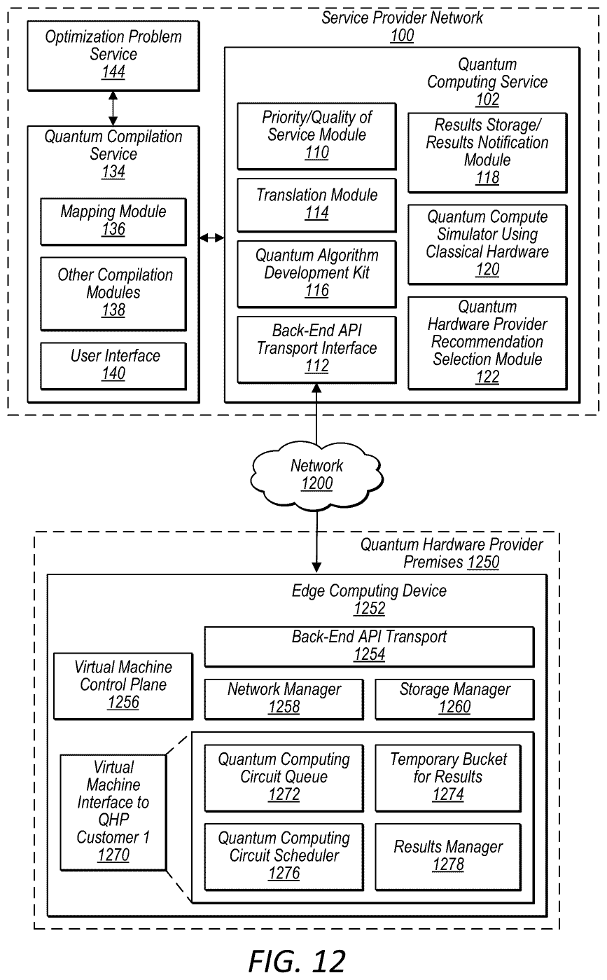

FIG. 12 illustrates an example edge computing device connected to a quantum computing service, according to some embodiments.

Service provider network 100 and quantum computing service 102 may be similar to the service provider networks and quantum computing services described herein, such as in FIG. 1A. Also, edge computing device 1252 may be a similar edge computing device as any of the edge computing devices described previously, such as in FIG. 1A or 11. Edge computing device 1252 may be connected to service provider network 100 via network connection 1200, which may be a logically isolated network connection via a public network, a dedicated physical non-public network link, or other suitable network connection.

Edge computing device 1252 may include network manager 1258, storage manager 1260, and virtual machine control plane 1256.

In some embodiments, a back-end application programmatic interface (API) transport of an edge computing device, such as back-end API transport 1254 of edge computing device 1252 may ping a quantum computing service to determine if there are one or more quantum tasks (e.g., quantum circuits) waiting to be transported to the edge computing device. The edge computing device may further use a non-public back-end API transport, such as back-end API transport 1254 to bring the quantum circuit into the edge computing device 1252.

Additionally, for each customer, a back-end API transport of an edge computing device of a quantum computing service, such as back-end API transport 1254 of edge computing device 1252, may cause a virtual machine to be instantiated to manage scheduling and results for a given quantum circuit pulled into the edge computing device from a back-end API. For example, virtual machine 1270 may act as an interface to the quantum hardware provider for a given customer (e.g., customer 1) of the service provider network. The edge computing device may be directly connected to a local non-public network at the quantum hardware provider location and may interface with a scheduling component of the quantum hardware provider to schedule availability (e.g., usage slots) on a quantum computer of the quantum hardware provider.

In some embodiments, the virtual machine 1270 may be booted with a particular quantum machine image that supports interfacing with the scheduling component of the quantum hardware provider, wherein different quantum hardware providers require different scheduling interfaces.

In some embodiments, virtual machine 1270 may be booted with a quantum circuit queuing component 1272, a quantum circuit scheduling component 1276, a component that manages a local storage bucket on the edge computing device to temporarily store results, such as temporary bucket 1274 and results manager 1278. In some embodiments, quantum circuit scheduling component 1276 may order quantum circuits in quantum circuit queuing component in the order they are received, wherein the received order enforces quality of service (QOS) guarantees by ordering the quantum tasks in the quantum task queue of the quantum computing service based on priorities determined using the QoS guarantees.

In some embodiments, an edge computing device, such as edge computing device 1252, may support multi-tenancy (e.g., service multiple customers of service provider network 100). Also, in some embodiments, edge computing device 1252 may also instantiate virtual machines that execute classical computing tasks, such as a classical computing portion of a hybrid algorithm. For example, virtual machine 1270 may be further configured to perform classical compute portions of a hybrid algorithm.

In some embodiments, a back-end API transport of an edge computing device located a quantum hardware provider location may interface with a back-end API transport interface 112 of a computing device/router at a remote location where one or more computing devices that implement the quantum computing service are located.

Note that edge computing device 1252 may be physically located (e.g., co-located) at quantum hardware provider premises 1250, such as in a building of a quantum hardware provider facility.

In some embodiments, the components of virtual machine 1270 may be included in back-end API transport 1254, and the back-end API transport 1254 may execute the related components within the back-end API transport without causing a separate VM 1270 to be instantiated.

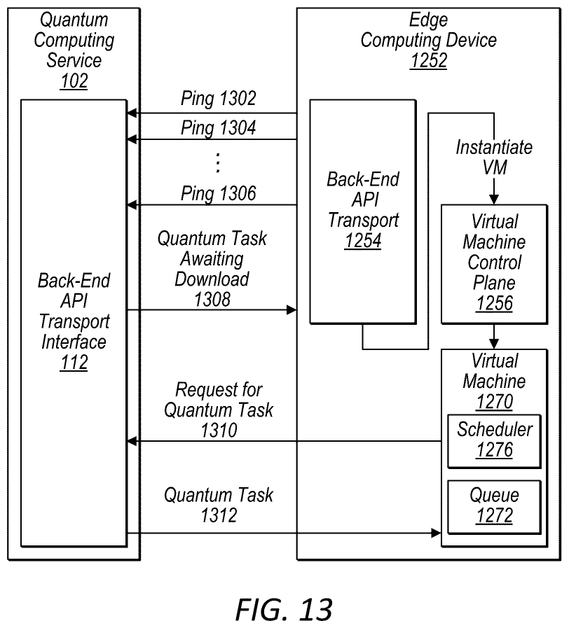

FIG. 13 illustrates example interactions between a quantum computing service and an edge computing device of the quantum computing service, according to some embodiments.

A back-end API transport 1254 of edge computing device 1252 may submit pings 1302, 1304, 1306, etc. to quantum computing service 102 to determine whether there is a quantum task (e.g., a quantum circuit) to be transported to edge computing device 1252. At 1308, the quantum computing service 102 may indicate to the edge computing device 1252 that there is a translated quantum circuit (e.g., a logical quantum circuit, such as logical quantum circuit 340, 440, or 540, that has been mapped to a given quantum hardware device of a given quantum hardware provider and translated into a format acceptable by the quantum hardware provider) ready to be transported to the edge computing device 1252. In response, back-end API transport 1254 may cause virtual machine control plane 1256 to instantiate a virtual machine 1270 to act as an interface for the customer to the quantum hardware provider. At 1310 the VM 1270 may call the back-end API transport 1254 requesting the translated quantum circuit (e.g., quantum task or batch of quantum tasks). In response, at 1312, the back-end API transport 1254 may cause the translated quantum circuit (e.g., quantum task or batch of quantum tasks) to be transported to the queue 1272 of VM 1270. In some embodiments, instead of pings of a polling protocol, an edge computing device 1252 may use various other techniques to determine whether there is a quantum computing circuit (e.g., quantum task or batch of quantum tasks) ready to be transported to edge computing device 1252. Also, in some embodiments, a given quantum hardware provider may include more than one quantum computer and/or types of quantum computers. In such embodiments, a back-end API transport and/or VM interface to the quantum hardware provider may route a quantum circuit that is to be executed at the quantum hardware provider to an assigned quantum computer at the quantum hardware provider.

In some embodiments, quantum tasks may come over to queue 1272 with associated access tokens and the quantum tasks may be ordered in queue 1272 based on their respective access tokens, or time stamps included in the respective access tokens.

### Illustrative Computer System

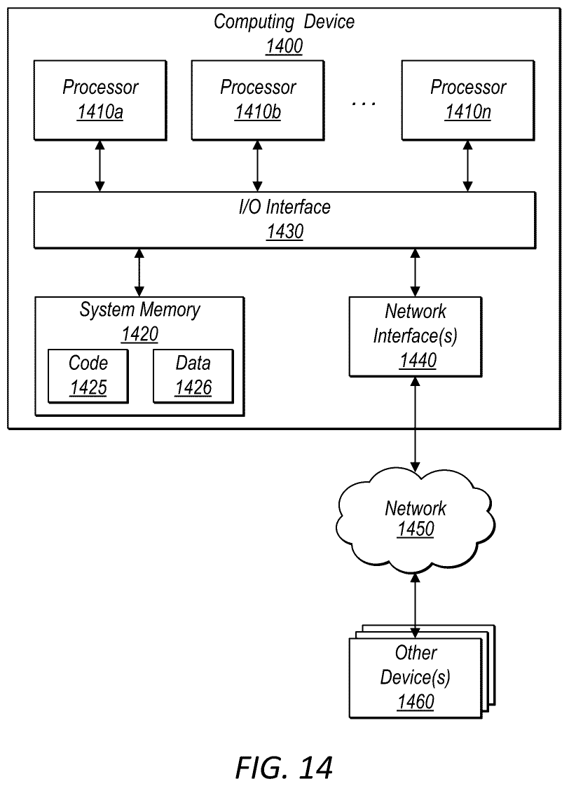

FIG. 14 is a block diagram illustrating an example computing device that may be used in at least some embodiments.

FIG. 14 illustrates such a general-purpose computing device 1400 as may be used in any of the embodiments described herein. In the illustrated embodiment, computing device 1400 includes one or more processors 1410 coupled to a system memory 1420 (which may comprise both non-volatile and volatile memory modules) via an input/output (I/O) interface 1430. Computing device 1400 further includes a network interface 1440 coupled to I/O interface 1430.

In various embodiments, computing device 1400 may be a uniprocessor system including one processor 1410, or a multiprocessor system including several processors 1410 (e.g., two, four, eight, or another suitable number). Processors 1410 may be any suitable processors capable of executing instructions. For example, in various embodiments, processors 1410 may be general-purpose or embedded processors implementing any of a variety of instruction set architectures (ISAs), such as the x86, PowerPC, SPARC, or MIPS ISAs, or any other suitable ISA. In multiprocessor systems, each of processors 1410 may commonly, but not necessarily, implement the same ISA. In some implementations, graphics processing units (GPUs) may be used instead of, or in addition to, conventional processors.

System memory 1420 may be configured to store instructions and data accessible by processor(s) 1410. In at least some embodiments, the system memory 1420 may comprise both volatile and non-volatile portions; in other embodiments, only volatile memory may be used. In various embodiments, the volatile portion of system memory 1420 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1420 as code 1425 and data 1426.

In some embodiments, I/O interface 1430 may be configured to coordinate I/O traffic between processor 1410, system memory 1420, and any peripheral devices in the device, including network interface 1440 or other peripheral interfaces such as various types of persistent and/or volatile storage devices. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. Also, in some embodiments some or all of the functionality of I/O interface 1430, such as an interface to system memory 1420, may be incorporated directly into processor 1410.

Network interface 1440 may be configured to allow data to be exchanged between computing device 1400 and other devices 1460 attached to a network or networks 1450, such as other computer systems or devices as illustrated in FIG. 1A through FIG. 13, for example. In various embodiments, network interface 1440 may support communication via any suitable wired or wireless general data networks, such as types of Ethernet network, for example. Additionally, network interface 1440 may support communication via telecommunications/telephony networks such as analog voice networks or digital fiber communications networks, via storage area networks such as Fibre Channel SANs, or via any other suitable type of network and/or protocol.

In some embodiments, system memory 1420 may represent one embodiment of a computer-accessible medium configured to store at least a subset of program instructions and data used for implementing the methods and apparatus discussed in the context of FIG. 1A through FIG. 13. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1400 via I/O interface 1430. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 1400 as system memory 1420 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1440. Portions or all of multiple computing devices such as that illustrated in FIG. 14 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system, comprising:
one or more computing devices of a service provider network configured to implement a quantum computing service, wherein the quantum computing service is configured to enable execution of quantum circuits using a plurality of quantum hardware devices; and
one or more computing devices of the service provider network configured to implement a quantum compilation service configured to compile instructions comprising a quantum circuit mapping for executing a logical quantum circuit using a given one of the quantum hardware devices, wherein to implement the quantum compilation service, the one or more computing devices are further configured to:
implement a reinforcement-learning-based (RL-based) quantum circuit router, wherein the RL-based quantum circuit router is configured to:
receive a request to generate the quantum circuit mapping;
generate, via a reinforcement learning model, one or more results of the quantum circuit mapping, wherein the one or more results comprise an ordering of quantum gates and SWAP gates to be performed to execute the logical quantum circuit using the given one of the quantum hardware devices; and
provide the one or more generated results to the quantum computing service,
wherein the one or more computing devices that implement the quantum computing service are further configured to submit the compiled instructions comprising the one or more generated results for use in execution of the logical quantum circuit using the given quantum hardware device.

2. The system of claim 1, wherein to generate, via the reinforcement learning model, the one or more results of the quantum circuit mapping, the RL-based quantum circuit router is further configured to:
select an action of a plurality of actions that change a current state of the quantum circuit mapping being generated, wherein the selected action causes a SWAP gate to be scheduled such that one or more respective ones of the quantum gates of the logical quantum circuit are additionally scheduled; and
update the current state of the quantum circuit mapping being generated to an updated state of the quantum circuit mapping being generated based, at least in part, on the selected action.

3. The system of claim 1, wherein the one or more computing devices of the service provider network configured to implement the RL-based quantum circuit router or one or more additional computing devices of the service provider network are configured to:
train the RL-based quantum circuit router, wherein to train the RL-based quantum circuit router, said one or more computing devices or the one or more additional computing devices are further configured to:
cause a Monte Carlo Tree Search (MCTS) algorithm to be performed, wherein the MCTS algorithm forecasts projected quantum gate scheduling paths based on respective ones of the plurality of actions; and
determine loss values corresponding to respective ones of the projected quantum gate scheduling paths, wherein the determined loss values are provided to a value network to update rewards of the reinforcement learning model used by a policy network of the RL-based quantum circuit router.

4. The system of claim 1, wherein to compile instructions comprising the quantum circuit mapping, the one or more computing devices of the service provider network configured to implement the quantum compilation service are further configured to:
generate initial qubit allocation information, wherein logical qubits of the logical quantum circuit are respectively assigned to one or more physical qubits located on the given one of the quantum hardware devices; and
provide the request to generate the quantum circuit mapping to the RL-based quantum circuit router, wherein the request comprises the generated initial qubit allocation information.

5. The system of claim 4, wherein:
the request to generate the quantum circuit mapping further comprises a noise model corresponding to the given one of the quantum hardware devices; and
the generated initial qubit allocation is additionally based, at least in part, on the noise model.

6. The system of claim 1, wherein:
the given one of the quantum hardware devices is a quantum hardware device of a quantum hardware provider;
the quantum hardware provider is accessible to the quantum compilation service via the service provider network; and
physical qubit connectivity information corresponding to the given one of the quantum hardware devices is provided via the service provider network.

7. The system of claim 1, wherein the RL-based quantum circuit router is further configured to:
update one or more rewards of the reinforcement learning model of the RL-based quantum circuit router based, at least in part, on the one or more generated results of the quantum circuit mapping.

8. A method, comprising:
receiving a request to generate compiled instructions comprising a quantum circuit mapping for executing a logical quantum circuit using a quantum hardware device;
determining a routing, via a reinforcement learning model, of quantum gates of the logical quantum circuit to physical qubits of the quantum hardware device, wherein said determining the routing comprises:
determining a plurality of actions that change a current state of the quantum circuit mapping being generated, wherein respective ones of the actions cause respective SWAP gates to be scheduled such that one or more respective ones of the quantum gates of the logical quantum circuit are additionally scheduled;
selecting an action from the plurality of actions;
updating the current state of the quantum circuit mapping being generated to an updated state of the quantum circuit mapping being generated based, at least in part, on the selected action;
performing a Monte Carlo Tree Search (MCTS), wherein the MCTS forecasts projected quantum gate scheduling paths corresponding to the selected action and to respective ones of the unselected plurality of actions;
determining loss values corresponding to respective ones of the projected quantum gate scheduling paths; and
repeating, for an additional plurality of actions, said determining the additional plurality of actions, said selecting an additional action from the plurality of additional actions, said updating the updated state such that respective ones of the quantum gates of the logical quantum circuit are routed, said performing the MCTS, and said determining updated loss values;
determining a mapping recommendation based, at least in part, on the determined routing; and
providing the mapping recommendation.

9. The method of claim 8, wherein said selecting the action from the plurality of actions is based, at least in part, on an action selection recommendation provided via a policy network of the reinforcement learning model, wherein the action selection recommendation comprises an indication of probabilities associated to respective ones of the determined plurality of actions.

10. The method of claim 8, wherein said selecting the action from the plurality of actions is based, at least in part, on a noise model corresponding to the quantum hardware device.

11. The method of claim 8, wherein said selecting the action from the plurality of actions is based, at least in part, on a forecasting recommendation of the MCTS, wherein the MCTS additionally forecasts the projected quantum gate scheduling paths prior to said selecting the action from the plurality of actions.

12. The method of claim 8, further comprising:
respectively allocating logical qubits of the logical quantum circuit to one or more of the physical qubits of the quantum hardware device, wherein said determining the routing, via the reinforcement learning model, of the quantum gates is based, at least in part, on said allocating.

13. The method of claim 8, further comprising:
respectively allocating logical qubits of the logical quantum circuit to one or more of the physical qubits of the quantum hardware device; and
determining, via the reinforcement learning model, a predicted number of SWAP gates that are to be scheduled during said determining the routing, via the reinforcement learning model, of the quantum gates, wherein said predicted number of SWAP gates is based, at least in part, on said allocating.

14. The method of claim 13, further comprising:
re-allocating, responsive to said determining the predicted number of SWAP gates, at least one of the logical qubits to one or more other physical qubits of the quantum hardware device such that an updated predicted number of SWAP gates that are to be scheduled during said determining the routing, via the reinforcement learning model, of the quantum gates, wherein:
the updated predicted number of SWAP gates is smaller than the predicted number of SWAP gates; and
said determining the routing, via the reinforcement learning model, of the quantum gates is based, at least in part, on said re-allocating.

15. The method of claim 8, further comprising:
updating one or more rewards of the reinforcement learning model based, at least in part, on one or more of the selected action and additional selected actions.

16. The method of claim 8, further comprising:
generating compiled instructions based, at least in part, on the determined routing, wherein:
the generated compiled instructions comprise an ordering of the quantum gates and the respective SWAP gates to be performed to execute the logical quantum circuit using the quantum hardware device; and
said determining the mapping recommendation is additionally based, at least in part, on the generated compiled instructions.

17. A non-transitory, computer-readable, medium storing program instructions that, when executed on or across one or more processors, cause the one or more processors to:
receive a request to generate compiled instructions comprising a quantum circuit mapping for executing a logical quantum circuit using a quantum hardware device;
determine a routing, via a reinforcement learning model, of quantum gates of the logical quantum circuit to physical qubits of the quantum hardware device,
wherein, to determine the routing the quantum gates, the program instructions further cause the one or more processors to:
determine a plurality of actions that change a current state of the quantum circuit mapping being generated, wherein respective ones of the actions cause respective SWAP gates to be scheduled such that one or more respective ones of the quantum gates of the logical quantum circuit are additionally scheduled;
select an action from the plurality of actions;
update the current state of the quantum circuit mapping being generated to an updated state of the quantum circuit mapping being generated based, at least in part, on the selected action;
execute a Monte Carlo Tree Search (MCTS) algorithm, wherein the MCTS algorithm forecasts projected quantum gate scheduling paths corresponding to the selected action and to respective ones of the unselected plurality of actions;
determine loss values corresponding to respective ones of the projected quantum gate scheduling paths; and
repeat, for an additional plurality of actions, said determine the additional plurality of actions, said select an additional action from the plurality of additional actions, said update the updated state such that respective ones of the quantum gates of the logical quantum circuit are routed, said execute the MCTS algorithm, and said determine updated loss values; and
provide results based, at least in part, on the determined routing.

18. The non-transitory, computer-readable medium of claim 17, wherein the program instructions further cause the one or more processors to:
respectively allocate logical qubits of the logical quantum circuit to one or more of the physical qubits of the quantum hardware device, wherein the determined routing is based, at least in part, on said allocation.

19. The non-transitory, computer-readable medium of claim 17, wherein the program instructions further cause the one or more processors to:
update one or more rewards of the reinforcement learning model based, at least in part, on one or more of the selected action and additional selected actions.

20. The non-transitory, computer-readable medium of claim 17, wherein the program instructions further cause the one or more processors to:
determine that a first projected quantum gate scheduling path of the projected quantum gate scheduling paths, corresponding to the selected action, comprises a number of SWAP gates that is smaller than another number of SWAP gates, corresponding to another action of the plurality of actions; and
determine rewards of the reinforcement learning model, wherein a larger reward is assigned to the number of SWAP gates that is smaller than the other number of SWAP gates.
